(19) United States
(12) Patent Application Publication
(10) Pub. No.: US 2016/0260351 A1
(43) Pub. Date: Sep. 8, 2016

(54) SYSTEM FOR PROVIDING NUTRITION DATA

(71) Applicant: TOSHIBA TEC KABUSHIKI KAISHA, Tokyo (JP)

(72) Inventors: Yumiko OKUMA, Nakano Tokyo (JP); Mahina NAKAMURA, Mitaka Tokyo (JP); Yasutsugu SASAKI, Yokohama Kanagawa (JP); Masanori SAMBE, Mishima Shizuoka (JP); Katsuhito MOCHIZUKI, Tagata Shizuoka (JP); Kyoshin SAI, Shinjuku Tokyo (JP)

(21) Appl. No.: 15/057,892

(22) Filed: Mar. 1, 2016

(30) Foreign Application Priority Data
Mar. 2, 2015 (JP) 2015-040627

(51) Int. Cl. G09B 19/00; G09B 5/02

(52) U.S. Cl. CPC G09B 19/0092; G09B 5/02

(57) ABSTRACT

A server for providing nutrition data to a user includes a communication interface, a memory, and a processor. The server receives from a user device a request for nutrition information of food and drink purchased by the user and user identification. The server determines a time period of the requested nutrition information. The server retrieves receipt data corresponding to the user identification and determined time period. The receipt data includes a first data for identifying the food and drink purchased by the user. The server also retrieves nutrition data corresponding to the foods and drink purchased by the user. The server generates and sends to the user device an image data that includes the nutrition.

### CROSS-REFERENCE TO RELATED APPLICATION

This application is based upon and claims the benefit of priority from Japanese Patent Application No. 2015-040627, filed Mar. 2, 2015, the entire contents of which are incorporated herein by reference.

### FIELD

Embodiments described herein relate to a system for providing nutrition data.

### BACKGROUND

There is known an application software that is capable of tracking calorie intake and nutritional balance of a meal through a computer, a smart phone and the like.

However, this kind of application is greatly troublesome since a user has to input data about ingested food and drink.

Further, it is proposed that a nutritional analysis of commodities purchased by a customer during a certain period is carried out by a POS system and the analyzed result is printed on a receipt.

However, the nutritional analysis is executed at a time when the commodities are purchased, and the commodities serving as objects of the nutritional analysis are all the commodities purchased during a certain period in the past. Thus, beneficial information to the user is not always provided to the user when the user desires.

Due to such circumstances, it is desired to easily provide to the user nutrition data relating to the ingested food and drink with less time and labor.

### DESCRIPTION OF THE DRAWINGS

FIG. 1 is a block diagram illustrating the whole structure of a system for providing nutrition data according to an embodiment.

FIG. 2 is a block diagram illustrating the structure of main portions of a checkout apparatus shown in FIG. 1.

FIG. 3 is a block diagram illustrating the structure of main portions of a user terminal device shown in FIG. 1.

FIG. 4 is a block diagram illustrating the structure of main portions of a receipt server shown in FIG. 1.

FIG. 5 is a diagram illustrating the data structure of receipt data.

FIG. 6 is a block diagram illustrating the structure of main portions of a browsing server shown in FIG. 1.

FIG. 7 is a block diagram illustrating the structure of main portions of a nutrition data server shown in FIG. 1.

FIG. 8 is a diagram illustrating the data structure of nutrition data.

FIG. 9 is a flowchart of a processing carried out by a processor in a checkout apparatus based on a settlement program shown in FIG. 2.

FIG. 10 is a flowchart of a processing carried out by a processor in a user terminal device based on a receipt client application shown in FIG. 3.

FIG. 11 is an additional flowchart of the processing carried out by the processor in the user terminal device based on the receipt client application shown in FIG. 3.

FIG. 12 is an additional flowchart of the processing carried out by the processor in the user terminal device based on the receipt client application shown in FIG. 3.

FIG. 13 is a diagram illustrating a login screen as an example.

FIG. 14 is a flowchart of a processing carried out by a processor in a receipt server based on a receipt server application shown in FIG. 4.

FIG. 15 is an additional flowchart of the processing carried out by the processor in the receipt server based on the receipt server application shown in FIG. 4.

FIG. 16 is a diagram illustrating a top screen as an example.

FIG. 17 is a flowchart of a processing executed in parallel with the processing shown in FIG. 14 and FIG. 15.

FIG. 18 is a diagram illustrating a receipt screen as an example.

FIG. 19 is a flowchart of a processing carried out by the processor in the user terminal device based on a health application shown in FIG. 3.

FIG. 20 is an additional flowchart of the processing carried out by the processor in the user terminal device based on the health application shown in FIG. 3.

FIG. 21 is a flowchart of the processing carried out by the processor in a browsing server based on a browsing server application shown in FIG. 6.

FIG. 22 is an additional flowchart of a processing carried out by a processor in the browsing server based on the browsing server application shown in FIG. 6.

FIG. 23 is a flowchart of a processing carried out by a processor in a nutrition data server based on a nutrition data server application shown in FIG. 7.

FIG. 24 is a diagram illustrating a nutrition browsing screen as an example.

FIG. 25 is a diagram illustrating a nutrition browsing screen as an example, and

FIG. 26 is a diagram illustrating a graph browsing screen as an example.

### DETAILED DESCRIPTION

A server for providing nutrition data to a user includes a communication interface, a memory, and a processor. The server receives from a user device a request for nutrition information of food and drink purchased by the user and user identification. The server determines a time period of the requested nutrition information. The server retrieves receipt data corresponding to the user identification and determined time period. The receipt data includes a first data for identifying the food and drink purchased by the user. The server also retrieves nutrition data corresponding to the foods and drink purchased by the user. The server generates and sends to the user device an image data that includes the nutrition.

A tracking system for nutrition data, according to an embodiment includes a first server that tracks food and drink purchases of a plurality of users, and a second server communicating with the first server of a network. The second server, in response to a request received from a user computing device: (i) queries the first server for data that meet conditions set forth in the request, the conditions including a user identification code and a time period of interest; (ii) generates nutrition data based on first data returned by the first server; (iii) transforms the nutrition data into image data; and (iv) transmits the image data representative of the nutrition data to the user computing device.

A tracking system for nutrition data, according to an embodiment includes a first server that tracks food and drink purchases of a plurality of users, and a second server communicating with the first server of a network, wherein the second server, in response to a request received from a user computing device: (i) queries the first server for data that meet conditions set forth in the request, the conditions including a user identification code and a time period of interest; (ii) generates nutrition data based on first data returned by the first server (iii) transforms the nutrition data into image data; and (iv) transmits the image data representative of the nutrition data to the user computing device.

Hereinafter, the embodiment of the system for providing nutrition data is described with reference to the accompanying drawings.

[Description of System for Providing Nutrition Data]

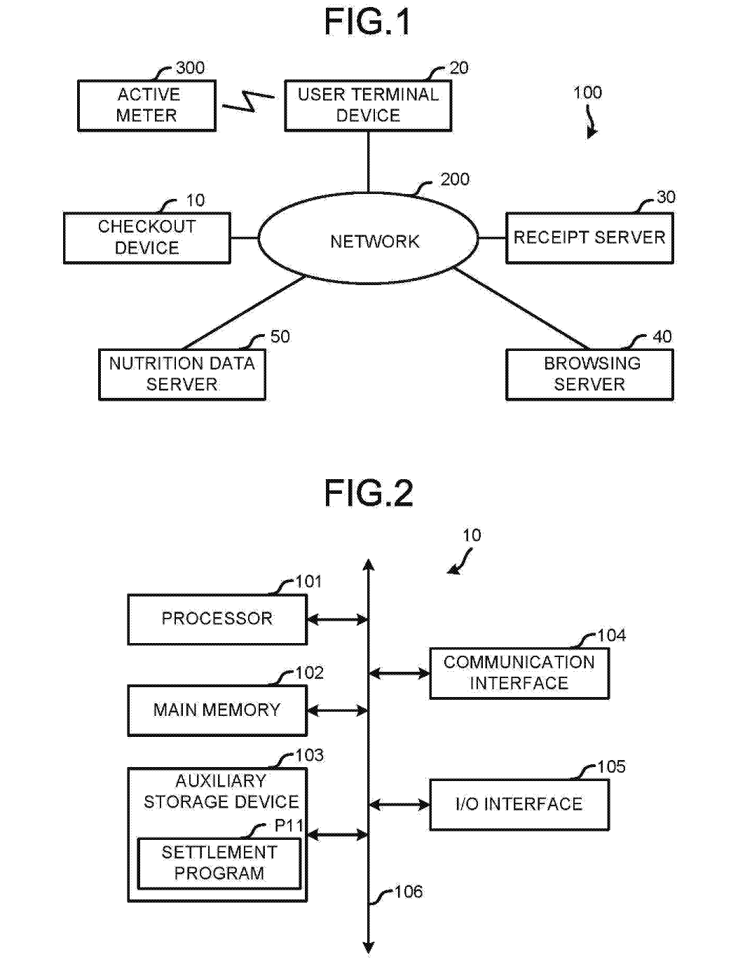

FIG. 1 is a block diagram illustrating the whole structure of a system for providing nutrition data (hereinafter, referred to as a “nutrition information system”) 100.

The nutrition information system 100 contains a checkout apparatus 10, a user terminal device 20, a receipt server 30, a browsing server 40 and a nutrition data server 50. In FIG. 1, the number of each of the checkout apparatus 10, the user terminal device 20, the receipt server 30, the browsing server 40 and the nutrition data server 50 is one. However, the number of each may be more than one. The checkout apparatus 10, the user terminal device 20, the receipt server 30, the browsing server 40 and the nutrition data server 50 can transmit and receive data via a network 200. The network 200 includes, for example, an Internet and a mobile communication network. The network 200 may include an LAN (local area network). The receipt server 30 and the browsing server 40 respectively act as a first server and a second server.

The checkout apparatus 10 is arranged at a store such as a restaurant that provides food and drink. The checkout apparatus 10 carries out a settlement processing for settling prices of the food and drink. The “settlement” contains calculation and settlement of the foregoing prices. If plural checkout apparatuses 10 are included in the nutrition information system 100, these plural checkout apparatuses 10 may be arranged in the same store or dispersedly arranged in different stores.

The user terminal device 20, on the basis of an operation by the user of the nutrition information system 100, displays an image for the user to browse nutrition data. If a plurality of user terminal devices 20 is included in the nutrition information system 100, these plural user terminal devices 20 may be used by the same user or individually used by different users. Alternatively, one user terminal device 20 may be shared by a plurality of users. The user terminal device 20 can wirelessly communicate with an activity meter 300. The activity meter 300, which is formed into, for example, a wristband shape, is used to measure the activity amount of the user who wears the activity meter 300. The user terminal device 20 acquires data of the activity amount from the activity meter 300. The user terminal device 20 can display the activity amount of the user and the nutrition data according to the acquired data.

The receipt server 30 stores receipt data indicating the result of the settlement carried out by the checkout apparatus 10. The receipt server 30 generates receipt screen data indicating the contents of the receipt data and sends the receipt screen data to the user terminal device 20.

The browsing server 40, according to the receipt data stored by the receipt server 30, generates nutrition screen data indicating nutrition data relating to the food and drink ingested by the user and sends the nutrition screen data to the user terminal device 20.

The nutrition data server 50 stores the nutrition data relating to the food and drink provided by the store where the checkout apparatus 10 is arranged. The nutrition data server 50, in response to a request from the receipt server 30 or the browsing server 40, sends necessary nutrition data to the receipt server 30 or the browsing server 40.

[Description of Checkout Apparatus 10]

FIG. 2 is a block diagram illustrating the structure of main portions of the checkout apparatus 10.

The checkout apparatus 10 is equipped with: a processor 101, a main memory 102, an auxiliary storage device 103, a communication interface 104, an I/O (input/output) interface 105 and a system transmission path 106. The processor 101 is connected with the main memory 102, the auxiliary storage device 103, the communication interface 104 and the I/O interface 105 through the system transmission path 106. The system transmission path 106 contains an address bus line, a data bus line and a control signal line.

In the checkout apparatus 10, the processor 101, the main memory 102, the auxiliary storage device 103 and the system transmission path 106 connecting these components together constitute a computer.

The processor 101 acts as the main unit of the computer. The processor 101 controls each section for realizing various functions of the checkout apparatus 10 according to an operating system and application programs.

The main memory 102 acts as the main memory unit of the computer. The main memory 102 includes a nonvolatile memory area and a volatile memory area. The main memory 102 stores the operating system and the application programs in the nonvolatile memory area. Further, there is a case in which the main memory 102 stores data needed by the processor 101 to execute processing to control each section in the nonvolatile or volatile memory area. The main memory 102 uses the volatile memory area as a working area for the processor 101 to properly rewrite data.

The auxiliary storage device 103 acts as the auxiliary storage unit of the computer. The auxiliary storage device 103 is, for example, an EEPROM (electric erasable programmable read-only memory), an HDD (hard disc drive) or an SSD (solid state drive). The auxiliary storage device 103 stores data used by the processor 101 to carry out various processing and data generated by the processing of the processor 101. The auxiliary storage device 103 stores the application programs.

The application programs stored in the auxiliary storage device 103 include a settlement program P11. However, the settlement program P11 may be, for example, downloaded via the Internet and may be written into the auxiliary storage device 103 in response to an operation executed by a manager of the checkout apparatus 10 or a setting operator of the checkout apparatus 10. That is, the settlement program P11 may be transferred to a user of the checkout apparatus 10 in a state in which the settlement program P11 is not stored in the auxiliary storage device 103.

The communication interface 104 is an interface for data communication via the network 200. For example, a well-known communication device for carrying out the data communication via the Internet can be used as the communication interface 104.

The I/O interface 105 is an interface for carrying out data communication with various input/output devices. The I/O interface 105 is suitably connected with, for example, a hand scanner, a touch panel, a card reader and a printer, though the connection is not shown.

An existing POS (point-of-sale) terminal device or an electronic cash register can be used as hardware of the checkout apparatus 10.

[Description of User Terminal Device 20]

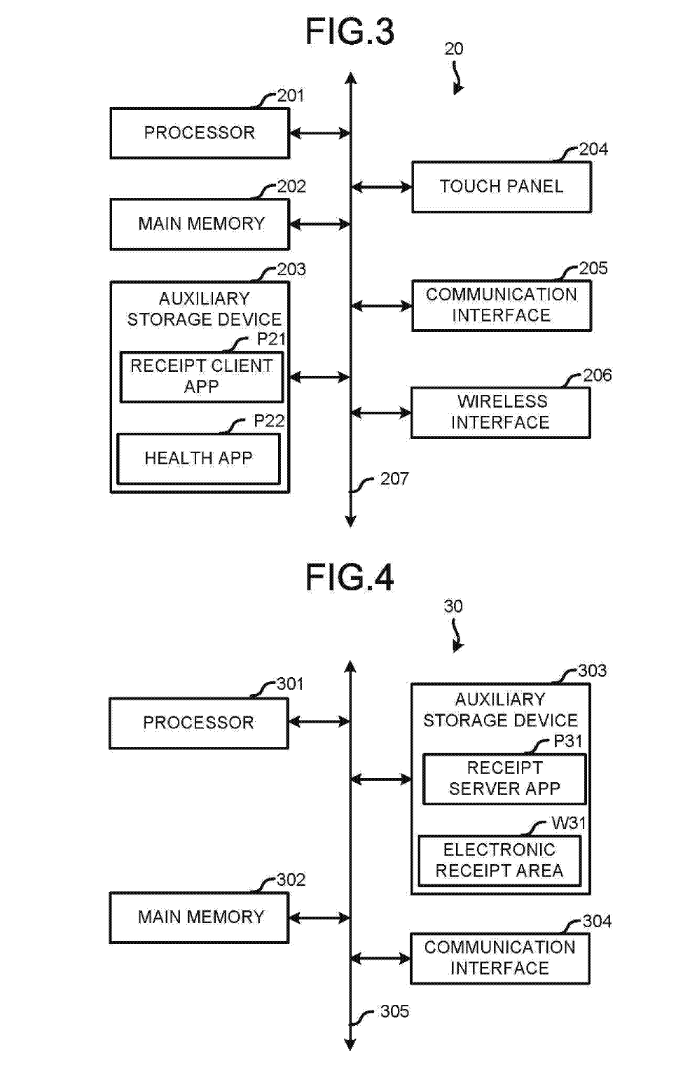

FIG. 3 is a block diagram illustrating the structure of main portions of the user terminal device 20.

The user terminal device 20 is a portable information processing apparatus such as a smart phone, a mobile phone or a tablet terminal. The user terminal device 20 may also be a stationary type information processing apparatus such as a desk-top personal computer.

The user terminal device 20 is provided with a processor 201, a main memory 202, an auxiliary storage device 203, a touch panel 204, a communication interface 205, a wireless interface 206 and a system transmission path 207. The processor 201 is connected with the main memory 202, the auxiliary storage device 203, the touch panel 204, the communication interface 205 and the wireless interface 206 via the system transmission path 207. The system transmission path 207 includes an address bus line, a data bus line and a control signal line.

In the user terminal device 20, the processor 201, the main memory 202, the auxiliary storage device 203 and the system transmission path 207 connecting these components together constitute a computer.

The processor 201 acts as the main unit of the computer. The processor 201 controls each section for realizing various functions of the user terminal device 20 according to an operating system and application programs.

The main memory 202 acts as the main memory unit of the computer. The main memory 202 includes a nonvolatile memory area and a volatile memory area. The main memory 202 stores the operating system and the application programs in the nonvolatile memory area. Further, these is a case in which the main memory 202 stores data needed by the processor 201 to execute processing to control each section in the nonvolatile or the volatile memory area. The main memory 202 uses the volatile memory area as a working area for the processor 201 to properly rewrite data.

The auxiliary storage device 203 acts as the auxiliary storage unit of the computer. The auxiliary storage device 203 may be, for example, an EEPROM. An HDD and an SSD may also be used as the auxiliary storage device 203. The auxiliary storage device 203 stores data used by the processor 201 to carry out various processing and data generated by the processing of the processor 201. The auxiliary storage device 203 stores the application programs.

The application programs stored in the auxiliary storage device 203 include application programs P21 and P22. The application program P21 is a control program for controlling the operation of the user terminal device as a receipt client. The application program P21 is hereinafter referred to as a receipt client application. The application program P22 is a control program for displaying the nutrition data relating to the food and drink. The application program P22 is hereinafter referred to as a health application. However, typically, the receipt client application P21 and the health application P22, for example, are downloaded via the Internet and written into the auxiliary storage device 203 in response to the operation by the user of the user terminal device 20. That is, the receipt client application P21 and the health application P22 are transferred to the user of the user terminal device 20 in a state in which the receipt client application P21 and the health application P22 are not stored in the auxiliary storage device 203. However, the receipt client application P21 and the health application P22 may be transferred to the user of the user terminal device 20 in a state in which the receipt client application P21 and the health application P22 are stored in the auxiliary storage device 203.

The touch panel 204 functions as an input device and a display device of the user terminal device 20. An icon for activating the receipt client application P21 through the processing of the processor 201 based on the operating system is displayed on the touch panel 204.

The communication interface 205 is an interface of data communication via the network 200. For example, a well-known communication device for carrying out data communication via a mobile communication network or the Internet can be used as the communication interface 205.

The wireless interface 206 is an interface of data communication using a wireless communication. For example, a well-known communication device based on a standard such as Bluetooth (registered trademark) and Wi-Fi can be used as the wireless interface 206. One of communication partners by the wireless interface 206 is the activity meter 300.

[Description of Receipt Server 30]

FIG. 4 is a block diagram illustrating the structure of main portions of the receipt server 30.

The receipt server 30 is provided with a processor 301, a main memory 302, an auxiliary storage device 303, a communication interface 304 and a system transmission path 305. The processor 301 is connected with the main memory 302, the auxiliary storage device 303 and the communication interface 304 through the system transmission path 305. The system transmission path 305 contains an address bus line, a data bus line and a control signal line.

In the receipt server 30, the processor 301, the main memory 302, the auxiliary storage device 303 and the system transmission path 305 connecting these components together constitute a computer.

The processor 301 acts as the main unit of the computer. The processor 301 controls each section for realizing various functions of the receipt server 30 according to an operating system and application programs.

The main memory 302 acts as the main memory unit of the computer. The main memory 302 includes a nonvolatile memory area and a volatile memory area. The main memory 302 stores the operating system and the application programs in the nonvolatile memory area. Further, there is a case in which the main memory 302 stores data needed by the processor 301 to execute processing to control each section in the nonvolatile or the volatile memory area. The main memory 302 uses the volatile memory area as a working area for the processor 301 to properly rewrite data.

The auxiliary storage device 303 acts as the auxiliary storage unit of the computer. The auxiliary storage device 303 is, for example, an EEPROM, an HDD and an SSD. The auxiliary storage device 303 stores data used by the processor 301 to carry out various processing and data generated by the processing of the processor 301. The auxiliary storage device 303 stores the foregoing application programs in some cases. One of application programs stored in the auxiliary storage device 303 is a control program (hereinafter, referred to as a “receipt server app”) P31 for controlling the operation of the receipt server 30.

The communication interface 304 is an interface of data communication via the network 200. For example, a well-known communication device for carrying out data communication via the Internet can be used as the communication interface 304.

The receipt server 30 can use, for example, a general server or computer as basic hardware. In a state in which the receipt server application P31 is not stored in the auxiliary storage device 303 of the receipt server 30, the server or computer and the receipt server application P31 may be individually transferred to the user of the receipt server 30. At this time, the receipt server application P31 can be transferred by being recorded in a removable recording medium such as a magnetic disk, a magneto-optical disk, an optical disk and a semiconductor memory or be downloaded via a network. In this case, the receipt server application P31 is written into the auxiliary storage device 303 in response to the operation of a manager of the receipt server 30 or a setting operator of the receipt server 30.

The processor 301 assigns a part of storage area of the auxiliary storage device 303 as an electronic receipt area W31 to carry out a processing based on the receipt server application P31. The electronic receipt area W31 stores the receipt data.

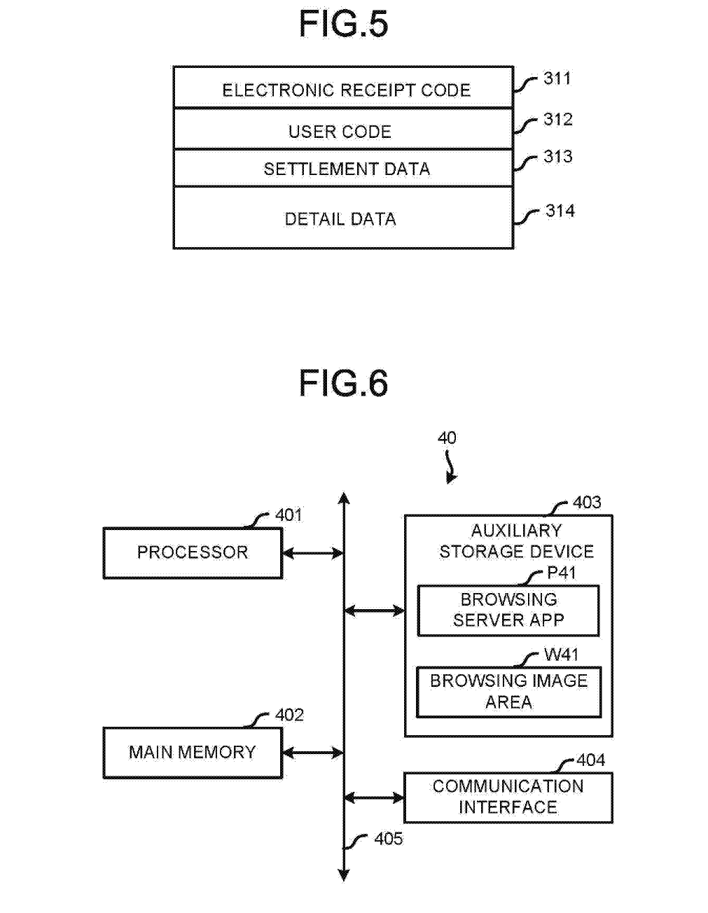

FIG. 5 is a diagram illustrating the data structure of the receipt data.

The receipt data contains an electronic receipt code 311, a user code 312, settlement data 313 and detail data 314.

The electronic receipt code 311 is a unique code for identifying each receipt data.

The user code 312 is a unique code for identifying the user of the nutrition information system 100.

The settlement data 313 represents the result of a settlement processing. The data included in the settlement data 313 is optional, and it is assumed that, for example, date and time when the settlement is carried out, a settlement amount, a settlement method or a store code of a store that carries out the settlement is contained. The store code is a unique code for identifying each of these plural stores in a case in which plural checkout apparatuses 10 are arranged in the plural stores.

Further, the receipt data contains time information acting as an index for determining a timing at which the user eats and drinks commodities. As the time information, a date and time when the user enters into the store or a date and time when the user orders commodities might be used.

The detail data 314 contains a list on which a commodity code, a name and a unit price relating to food and drink to be settled are displayed.

[Description of Browsing Server 40]

FIG. 6 is a block diagram illustrating the structure of main portions of the browsing server 40.

The browsing server 40 is provided with a processor 401, a main memory 402, an auxiliary storage device 403, a communication interface 404 and a system transmission path 405. The processor 401 is connected with the main memory 402, the auxiliary storage device 403 and the communication interface 404 through the system transmission path 405. The system transmission path 405 includes an address bus line, a data bus line and a control signal line.

In the browsing server 40, the processor 401, the main memory 402, the auxiliary storage device 403 and the system transmission path 405 connecting these components together constitute a computer.

The processor 401 acts as the main unit of the computer. The processor 401 controls each section for realizing various functions of the browsing server 40 according to an operating system and application programs.

The main memory 402 acts as the main memory unit of the computer. The main memory 402 contains a nonvolatile memory area and a volatile memory area. The main memory 402 stores the operating system and the application programs in the nonvolatile memory area. Further, there is a case in which the main memory 402 stores data needed by the processor 401 to execute processing to control each section in the nonvolatile or the volatile memory area. The main memory 402 uses the volatile memory area as a working area for the processor 401 to properly rewrite data.

The auxiliary storage device 403 acts as the auxiliary storage unit of the computer. The auxiliary storage device 403 is, for example, an EEPROM, an HDD and an SSD. The auxiliary storage device 403 stores data used by the processor 401 to carry out various processing and data generated by the processing carried out by the processor 401. The auxiliary storage device 403 stores the application programs. One of the application programs stored in the auxiliary storage device 403 is a control program (hereinafter, referred to as a “browsing server app”) P41 for controlling the operation of the browsing server 40.

The communication interface 404 is an interface of data communication via the network 200. For example, a well-known communication device for carrying out data communication via the Internet can be used as the communication interface 404.

The browsing server 40 can use, for example, a general server or computer as basic hardware. In a state in which the browsing server application P41 is not stored in the auxiliary storage device 403 of the browsing server 40, the browsing server application P41 may be individually transferred to the user. At this time, the browsing server application P41 can be transferred by being recorded in a removable recording medium such as a magnetic disk, a magneto-optical disk, an optical disk and a semiconductor memory or be downloaded via a network. In this case, in response to the operation of a manager of the browsing server 40 or a setting operator of the browsing server 40, the browsing server application P41 is written into the auxiliary storage device 403.

The processor 401 assigns a part of storage area of the auxiliary storage device 403 as a browsing image area W41 to execute a processing based on the browsing server application P41.

The browsing image area W41 stores browsing image data indicating a browsing image described later.

[Description of Nutrition Data Server 50]

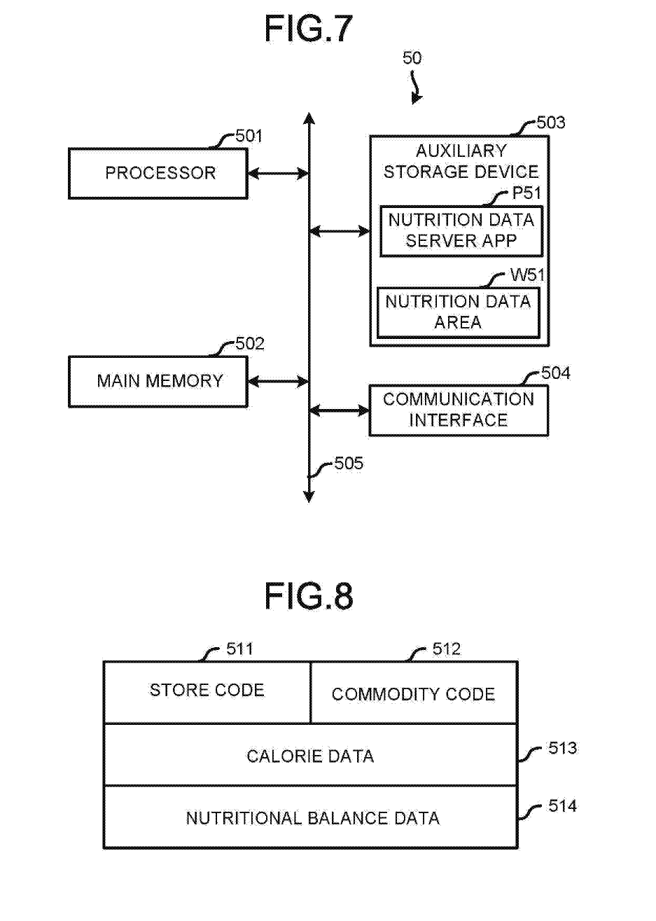

FIG. 7 is a block diagram illustrating the structure of main portions of the nutrition data server 50.

The nutrition data server 50 is provided with a processor 501, a main memory 502, an auxiliary storage device 503, a communication interface 504 and a system transmission path 505. The processor 501 is connected with the main memory 502, the auxiliary storage device 503 and the communication interface 504 through the system transmission path 505. The system transmission path 505 includes an address bus line, a data bus line and a control signal line.

In the nutrition data server 50, the processor 501, the main memory 502, the auxiliary storage device 503 and the system transmission path 505 connecting these components together constitute a computer.

The processor 501 acts as the main unit of the computer. The processor 501, according to an operating system and application programs, controls each section for realizing various functions of the nutrition data server 50.

The main memory 502 acts as the main memory unit of the computer. The main memory 502 contains a nonvolatile memory area and a volatile memory area. The main memory 502 stores the operating system and the application programs in the nonvolatile memory area. Further, there is a case in which the main memory 502 stores data needed by the processor 501 to execute processing to control each section in the nonvolatile or the volatile memory area. The main memory 502 uses the volatile memory area as a working area for the processor 501 to properly rewrite data.

The auxiliary storage device 503 acts as the auxiliary storage unit of the computer. The auxiliary storage device 503 is, for example, an EEPROM, an HDD and an SSD. The auxiliary storage device 503 stores data used by the processor 501 to carry out various processing and data generated by the processing of the processor 501. The auxiliary storage device 503 stores the application programs. One of the application programs stored in the auxiliary storage device 503 contains a control program (hereinafter, referred to as a “nutrition data server app”) P51 for controlling the operation of the nutrition data server 50. A part of storage area of the auxiliary storage device 503 can be used as a nutrition data area W51. The nutrition data area W51 stores nutrition data about each of the foods and drinks provided by the store in which the checkout apparatus 10 is arranged.

FIG. 8 is a diagram illustrating the data structure of the nutrition data.

The nutrition data contains a store code 511, a commodity code 512, calorie data 513 and nutritional balance data 514.

The store code 511 is a code for identifying a store in which the checkout apparatus 10 is arranged, and is the same series as the store code contained in the receipt data.

The commodity code 512 is a code for identifying the food and drink. The commodity code 512 may be unique to each of the foods and drinks provided by the store identified by the store code 511. That is, the commodity codes 512 respectively contained in the individual nutrition data containing different store codes 511 may be different from each other for the same food and drink. However, the commodity code 512 is coincident with the commodity code contained in the receipt data generated by the checkout apparatus 10 arranged in the store identified by the store code 511.

The calorie data 513 indicates the calorie of the food and drink identified by the commodity code 512 among the foods and drinks provided by the store identified by the store code 511.

The nutritional balance data 514 indicates the nutritional balance of the food and drink identified by the commodity code 512 among the foods and drinks provided by the store identified by the store code 511. The nutritional balance data indicates amount of energy of each of plural nutrients defined by, for example, a four food-group scoring method. The nutritional balance data 514 may consist of contents of the nutrients such as salts, carbohydrates, lipids, proteins, minerals, vitamins and the like.

It is assumed that the checkout apparatuses 10 are respectively arranged in a store A and a store B which are different from each other. Although recipes of stores A and B are different from each other, either of the stores A and B provides a commodity whose name is a “set meal with grilled meat”. In this case, the same commodity code may be used in individual checkout apparatus 10 of stores A and B. In this case, nutrition data containing the commodity code of the commodity “set meal with grilled meat” as the commodity code 512 is stored in two nutrition data areas W51. One of two nutrition data consists of a store code 511 for identifying the store A, calorie data 513 of “set meal with grilled meat” provided in the store A and nutritional balance data 514. Further, the other of two nutrition data consists of a store code 511 for identifying the store B, calorie data 513 of “set meal with grilled meat” provided in the store B and nutritional balance data 514.

The communication interface 504 is an interface for data communication via the network 200. For example, a well-known communication device for carrying out data communication via an Internet can be used as the communication interface 504.

The nutrition data server 50 can use, for example, a general server or computer as basic hardware. In a state in which the nutrition data server application P51 is not stored in the auxiliary storage device 503 of the nutrition data server 50, the server or computer and the nutrition data server application P51 may be respectively transferred to the user. At this time, the nutrition data server application P51 can be transferred by being recorded in a removable recording medium such as a magnetic disk, a magneto-optical disk, an optical disk and a semiconductor memory or be downloaded via a network. In this case, in response to an operation of a manager of the nutrition data server 50 or a setting operator of the nutrition data server 50, the nutrition data server application P51 is written into the auxiliary storage device 503.

[Description of Operation of Nutrition Information System 100]

Next, the operation of the nutrition information system 100 is described. Contents of various processing described below are an example, and various other processing capable of obtaining the same result can be properly used.

The user of the nutrition information system 100 installs the receipt client application P21 and the health application P22 in the user terminal device 20. The user carries out a user registration to the receipt server 30 using a predetermined method. Through the user registration, in the receipt server 30, a unique user code for identifying the user is determined. Further, a user name and a password designated by the user are both associated with the user code. In the present embodiment, it is assumed that a mail address is used as the user name. The user name and/or the password may be arbitrarily determined by the receipt server 30.

The user, if meal at the store in which the checkout apparatus 10 belonging to the nutrition information system 100 is arranged, uses the checkout apparatus 10 to settle the drinks and foods.

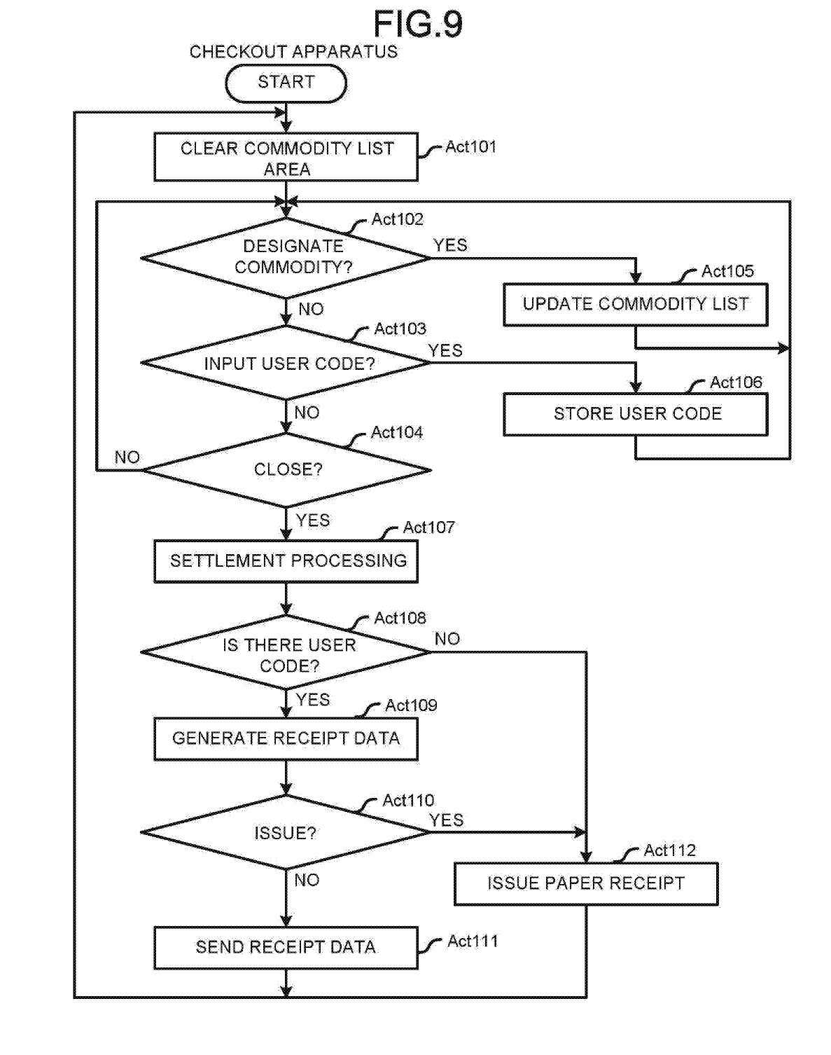

FIG. 9 is a flowchart of the processing of the processor 101 based on the settlement program P11 of the checkout apparatus 10.

In Act 101, the processor 101 clears a commodity list area set in the main memory 102. The commodity list area is a storage area for describing a list of information relating to registered purchase-commodities (hereinafter, referred to as a “commodity list”).

In Act 102, the processor 101 confirms whether a commodity to be purchase-registered is designated. If the result of the determination is “No” because the commodity is not designated, the processor 101 proceeds to Act 103.

In Act 103, the processor 101 confirms whether a user code is input. If the result of the determination is “No” because the user code is not input, the processor 101 proceeds to Act 104.

In Act 104, the processor 101 confirms whether the purchase-registration processing is supposed to be closed. If the result of the determination is “No” because an operation of designating the close of the purchase-registration processing is not carried out, the processor 101 returns to Act 102.

In this way, the processor 101 waits for until any one of the designation of the commodity, the input of the user code or the operation of designating the close is carried out in Act 102-Act 104.

The user who finishes the meal at the store in which the checkout apparatus 10 is arranged brings an order slip to an accounting zone and delivers the order slip to a shop clerk who takes charge of the accounting zone. The shop clerk operates the input/output devices connected with the I/O interface 105 to designate the commodity recorded on the order slip. For example, the shop clerk touches a commodity selection button displayed on the touch panel serving as one of the input/output devices. If the result of the determination in Act 102 is “Yes” because the commodity is designated, the processor 101 proceeds to Act 105.

In Act 105, the processor 101 updates the commodity list in such a manner that the commodity list contains the designated commodity. The processor 101 afterwards returns to a wait state in Act 102-Act 104. Further, an order list created according to a commodity designation processing at another order terminal may be acquired as a commodity list.

On the other hand, in a case of hoping to use an electronic receipt service for the foregoing settlement, the user activates a processing based on the receipt client application P21 in the user terminal device 20.

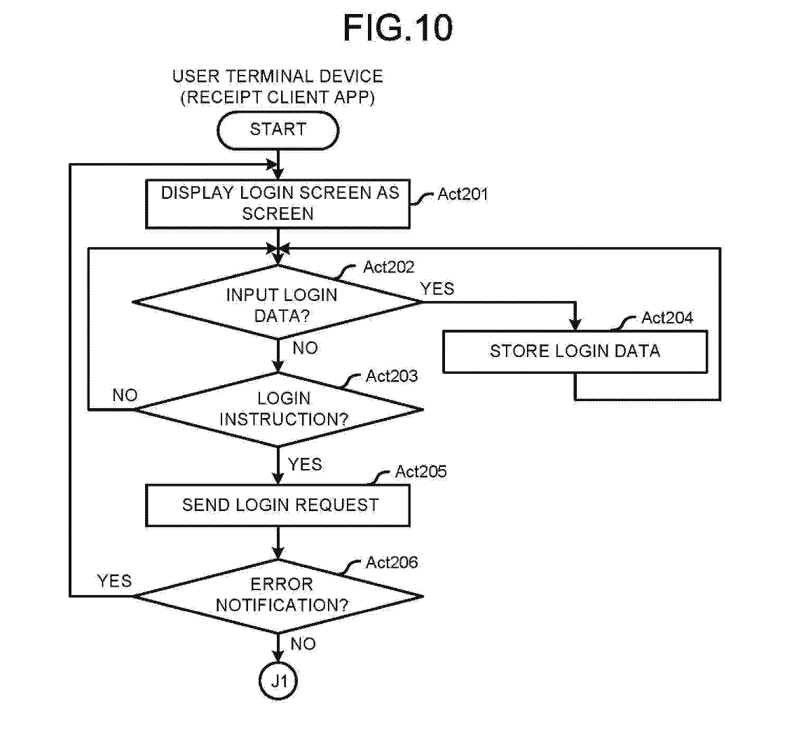

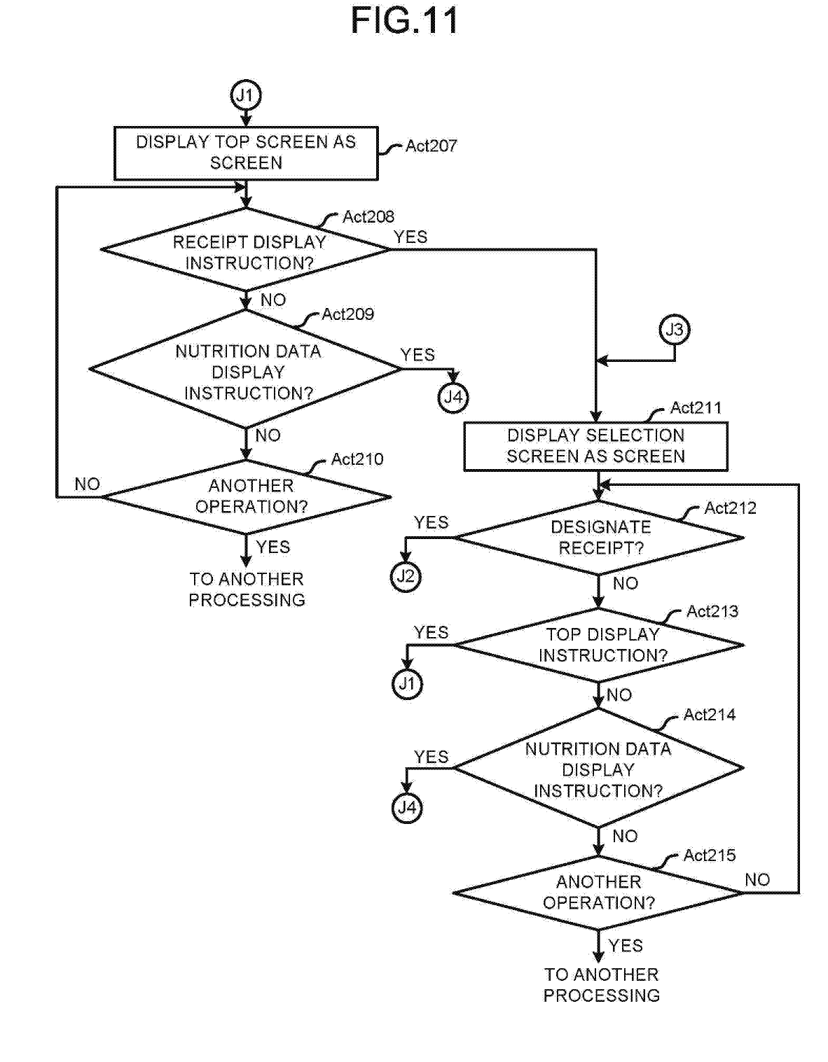

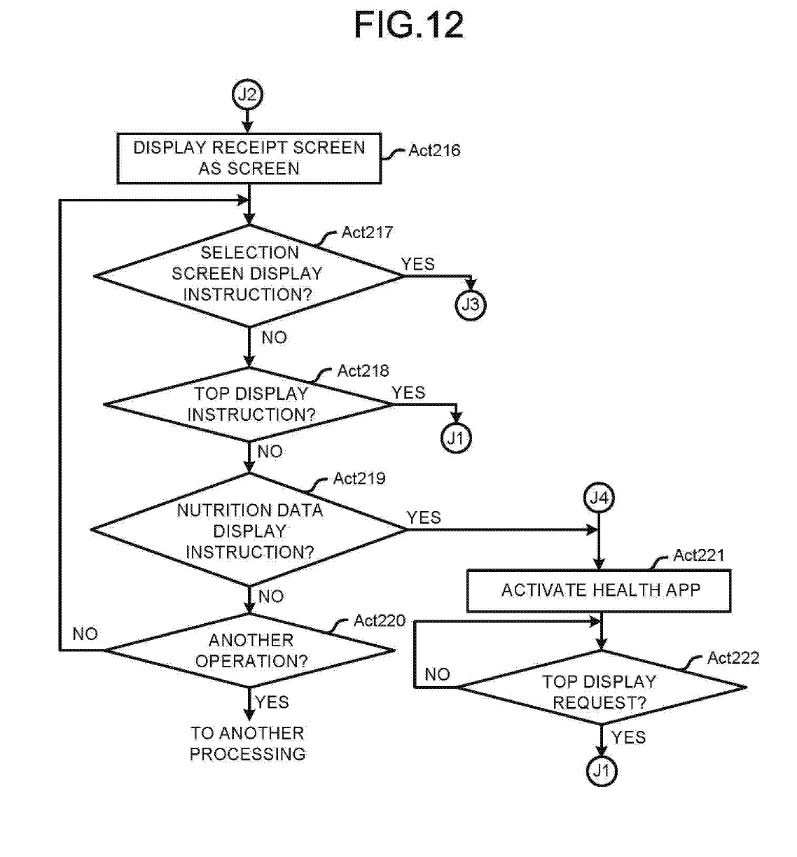

FIG. 10, FIG. 11 and FIG. 12 are flowcharts of the processing of the processor 201 based on the receipt client application P21 of the user terminal device 20.

In Act 201 of FIG. 10, the processor 201 displays a login screen as a screen on the touch panel 204.

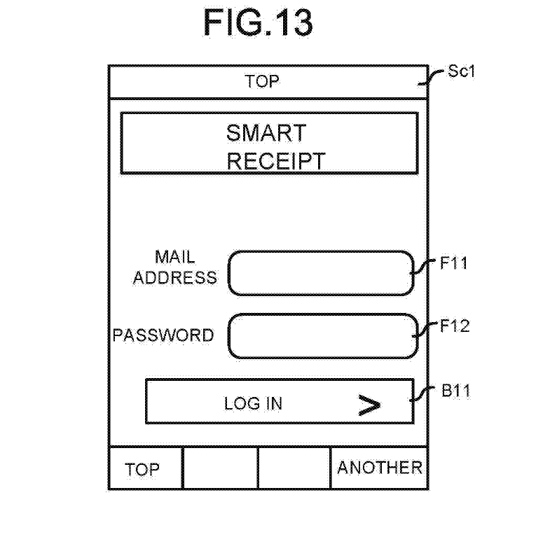

FIG. 13 is a diagram illustrating a login screen Sc1 as an example.

The login screen Sc1 displays input columns F11 and F12 and a button B11.

The input column F11 is a column for the user to input the mail address set as the user name. The input column F12 is a column for the user to input the password that is associated with the user code together with the mail address. The button B11 is touched by the user to instruct a login operation.

The user separately inputs the mail address and the password designated at the time of the user resignation in the input columns F11 and F12 and then touches the button B11.

Then, in Act 202, the processor 201 confirms whether login data is input. If the result of the determination is “No” because no data is input in either of the input column F11 and the input column F12, the processor 201 proceeds to Act 203.

In Act 203, the processor 201 confirms whether the login is instructed. If the result of the determination is “No” because the button B11 is not touched, the processor 201 returns to Act 202.

In this way, in Act 202 and Act 203, the processor 201 waits for the input of the mail address or the password or the instruction of the login. If the result of the determination in Act 202 is “Yes” because data is input in either of the input column F11 and the input column F12, the processor 201 proceeds to Act 204.

In Act 204, the processor 201 stores the input login data into the main memory 202. Specifically, if the data is input in the input column F11, the processor 201 stores the input data in the main memory 202 as the mail address. Further, if the data is input in the input column F12, the processor 201 stores the input data in the main memory 202 as the password. Then, the processor 201 returns to a wait state in Act 202 and Act 203.

If the result of the determination in Act 203 is “Yes” because the button B11 is touched, the processor 201 proceeds to Act 205.

In Act 205, the processor 201 sends a login request containing the login data (mail address and password) stored in the main memory 202 from the communication interface 205 to the receipt server 30 via the network 200.

If the login request is transmitted to the receipt server 30 via the network 200, the communication interface 304 receives the login request. The communication interface 304 stores received login request in the main memory 302 or the auxiliary storage device 303.

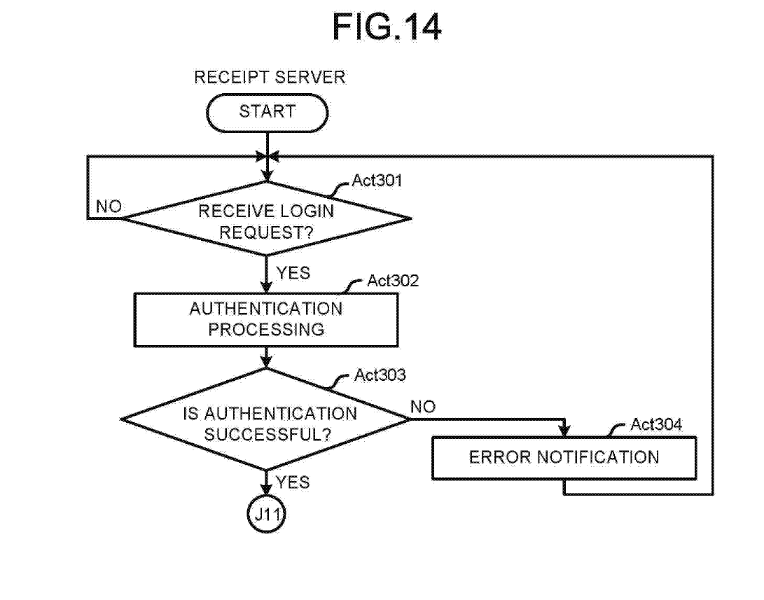

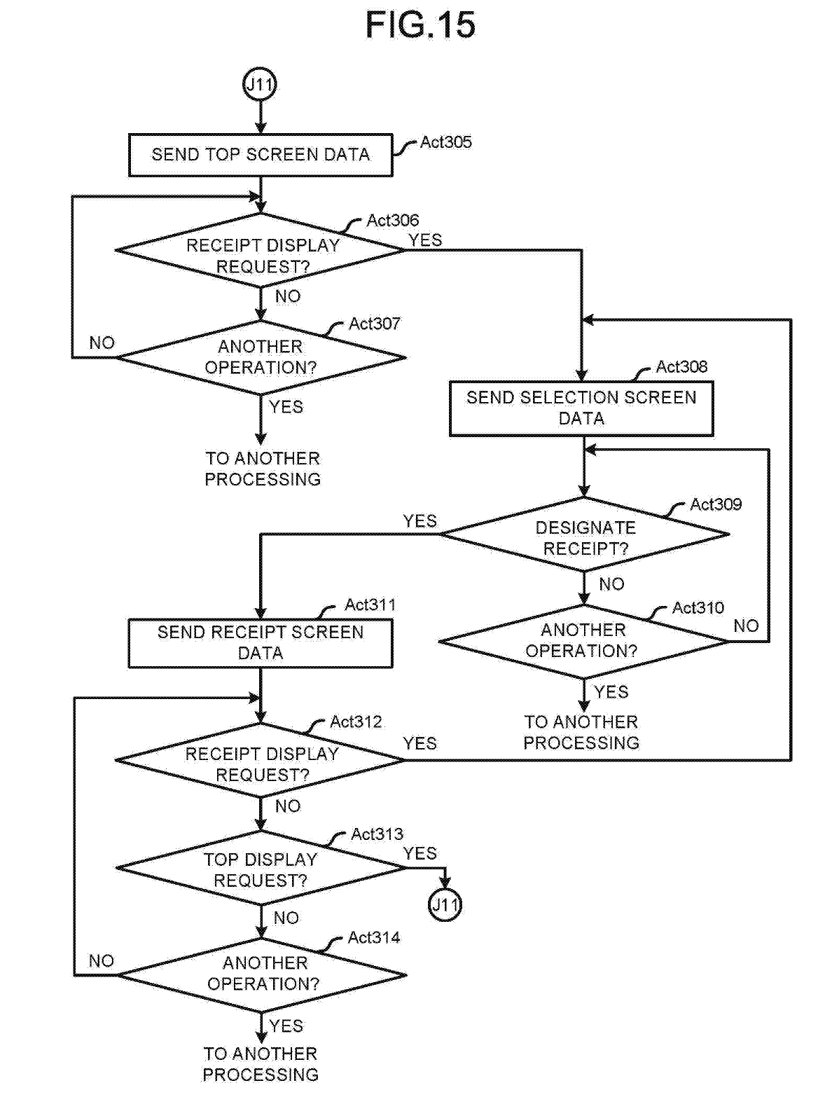

FIG. 14 and FIG. 15 are flowcharts of the processing of the processor 301 based on the receipt server application P31 of the receipt server 30.

In Act 301 of FIG. 14, the processor 301 confirms whether the login request is received. If the result of the determination is “No” because the login request is not received by the communication interface 304 as stated above, the processor 301 repeats Act 301. In this way, in Act 301, the processor 301 waits for the receiving of the login request. If the result of the determination is “Yes” because the login request is received by the communication interface 304 as stated above, the processor 301 proceeds to Act 302.

In Act 302, the processor 301 carries out an authentication processing on the basis of the login data contained in the received login request. Specifically, the processor 301 confirms whether the user code associated with the mail address and the password contained in the login request is set.

In Act 303, the processor 301 confirms whether the authentication is successful. If the result of the determination is “No” because the user code associated with the mail address and the password is not set, the processor 301 proceeds to Act 304.

In Act 304, the processor 301 sends an error notification from the communication interface 304 to the user terminal device 20 via the network 200. Then, the processor 301 returns to a wait state in Act 301.

If the result of the determination in Act 303 is “Yes” because the user code associated with the mail address and the password is set, the processor 301 proceeds to Act 305 in FIG. 15. Further, in this case, the processor 301 stores previously the user code associated with the mail address and the password in the main memory 302 as a user code of a user who is in login process. In this way, through the execution of a control processing based on the receipt server application P31 by the processor 301, the computer taking the processor 301 as the main unit functions as a second acquisition module.

In Act 305, the processor 301 generates top screen data and sends the generated top screen data from the communication interface 304 to the user terminal device 20 via the network 200.

The top screen data includes the foregoing user code while displaying an image for showing that the screen of the touch panel 204 of the user terminal device 20 becomes a top screen.

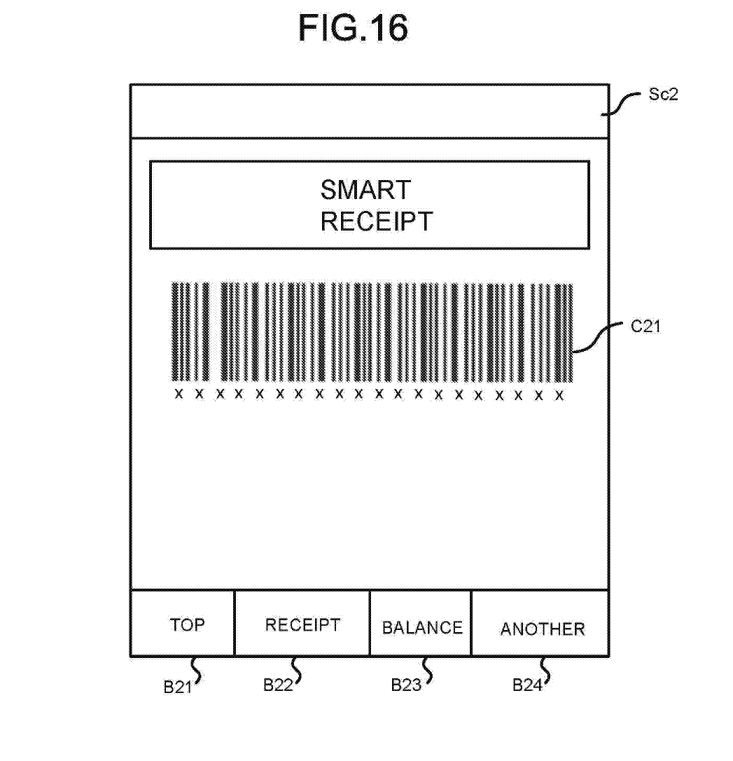

FIG. 16 is a diagram illustrating a top screen Sc2 as an example.

The top screen Sc2 displays a barcode C21 and buttons B21, B22, B23 and B24.

The barcode C21 indicates the user code associated with the mail address and the password contained in the login request. The button B21 is touched by the user to instruct the switch to the top screen. The button B22 is touched by the user to instruct the switch to a receipt browsing screen. The button B23 is touched by the user to instruct the switch to a nutrition browsing screen. The button B24 is touched by the user to instruct the switch to other screen except the top screen, the receipt browsing screen and the nutrition browsing screen. The other screen is, for example, a screen for receiving a user operation of carrying out various settings.

The buttons B21, B22, B23 and B24 each have an indicator function for indicating which screen is the current screen. Because FIG. 16 shows the top screen Sc2, the frame of the button B21 is thicker than that of other buttons B22-B24.

Then, the processor 201, after sending the login request in Act 205 shown in FIG. 10, proceeds to Act 206.

In Act 206, the processor 201 confirms whether an error is notified. If the error notification is transmitted to the user terminal device 20 via the network 200, the communication interface 205 receives the error notification. The communication interface 205 notifies the processor 201 of a message that the error notification is received. If the result of the determination in Act 206 is “Yes” because the error is notified, the processor 201 returns to Act 201 to repeat the processing thereafter similarly to that described above.

If the top screen data is transmitted to the user terminal device 20 via the network 200, the communication interface 205 receives the top screen data. The communication interface 205 stores the top screen data into the main memory 202 or the auxiliary storage device 203. Consequentially, the processor 201 determines the result in Act 206 is “No”. Then, the processor 201 in this case proceeds to Act 207 in FIG. 11.

In Act 207, the processor 201 displays the top screen as the screen of the touch panel 204 according to the received top screen data. In this way, the barcode indicating the user code is displayed on the screen of the touch panel 204.

The user presents the user terminal device 20 on which the barcode is displayed to the shop clerk. The shop clerk uses the hand scanner serving as one of the input/output devices connected with I/O interface 105 of the checkout apparatus 10 to read the barcode.

In the checkout apparatus 10, if the result of the determination in Act 103 of FIG. 9 is “Yes” because the barcode is read by the hand scanner as stated above, the processor 101 proceeds to Act 106.

In Act 106, the processor 101 stores the user code indicated by the read barcode in the main memory 102 or the auxiliary storage device 103. Then, the processor 101 returns to the wait state in Act 102-Act 104. Thus, although there is a case in which the barcode is read many times, in this case, the user code which is already stored in the main memory 102 or the auxiliary storage device 103 is overwritten with a user code indicated by a barcode which is read finally. The user code acts as an identification code for identifying a user. In this way, through the execution of the control processing based on the settlement program P11 by the processor 101, the computer taking the processor 101 as the main unit functions as a first acquisition module.

If the designation of all the commodities recorded on the slip is complete, the shop clerk touches, for example, a subtotal button displayed on the touch panel serving as one of the input/output devices. If the result of the determination in Act 104 is “Yes” because such an operation of designating the close of the purchase-registration processing is carried out, the processor 101 proceeds to Act 107.

In Act 107, the processor 101 carries out a settlement processing for settling the prices relating to the commodities shown in the commodity list. The settlement processing can use a processing executed by an existing POS apparatus as it is.

In this way, through the execution of the control processing based on the settlement program P11 by the processor 101, the computer taking the processor 101 as the main unit functions as a settlement module.

In Act 108, the processor 101 confirms whether the user code is stored in the main memory 102 or the auxiliary storage device 103. If the result of the determination is “Yes” because the user code is stored, the processor 101 proceeds to Act 109.

In Act 109, the processor 101 creates receipt data with the structure shown in FIG. 5. In this way, through the execution of the control processing based on the settlement program P11 by the processor 101, the computer taking the processor 101 as the main unit functions as a first generation module.

In Act 110, the processor 101 confirms whether a paper receipt is issued. Specifically, the processor 101 displays a screen on the touch panel to inquire of the user about whether to hope to issue a paper receipt. If the result of the determination is “No” because a message indicating no issue of the paper receipt is input through the operation on the touch panel, the processor 101 proceeds to Act 111. The processor 101 may omit Act 110 and proceed to Act 111 from Act 109 directly.

In Act 111, the processor 101 sends the receipt data created in Act 109 to the receipt server 30. Specifically, the processor 101 generates a transmission file consisting of the receipt data created in Act 109 and the user code stored in the main memory 102 or the auxiliary storage device 103. Then, the processor 101 sends the foregoing transmission file from the communication interface 104 to the receipt server 30 via the network 200. Afterwards, the processor 101 returns to Act 101 to redo the processing thereafter similarly to that described above.

If the result of the determination in Act 108 is “No” because the user code is not stored, the processor 101 proceeds to Act 112. In a case in which the result of the determination in Act 110 is “Yes” because a message indicating the issue of the paper receipt is input through the operation on the touch panel, the processor 101 proceeds to Act 112.

In Act 112, the processor 101 controls a printer serving as one of the input/output devices connected with the I/O interface 105 to issue the paper receipt. Then, the processor 101 returns to Act 101 to redo the processing thereafter similarly to that described above.

If the transmission file containing the receipt data is transmitted to the receipt server 30 via the network 200, the communication interface 304 receives the transmission file. The communication interface 304 stores the received transmission file in the main memory 302 or the auxiliary storage device 303.

In the receipt server 30, the processor 301 executes a processing other than the processing shown in FIG. 14 and FIG. 15 in parallel with the processing shown in FIG. 14 and FIG. 15 according to another task.

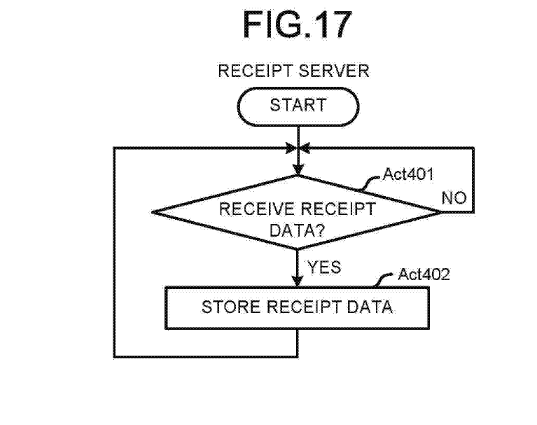

FIG. 17 is a flowchart of such a processing.

In Act 401, the processor 301 confirms whether the receipt data is received. If the result of the determination is “No” because the transmission file containing the receipt data is not received as stated above, the processor 301 repeats Act 401. In this way, in Act 401, the processor 301 waits for the receiving of the transmission file containing the receipt data. If the result of the determination is “Yes” because the transmission file containing the receipt data is received as stated above, the processor 301 proceeds to Act 402.

In Act 402, the processor 301 stores the receipt data contained in the received transmission file in the electronic receipt area W31 of the auxiliary storage device 303 in association with the user code contained in the same transmission file. Afterwards, the processor 301 returns to a wait state of Act 401 and prepares for receiving a new transmission file.

As stated above, the receipt data relating to the meal of the user is stored in the auxiliary storage device 303 of the receipt server 30. In this way, the auxiliary storage device 303 acts as the storage device.

Then, after the screen of touch panel 204 of the user terminal device 20 is displayed as the top screen in Act 207 of FIG. 11, the processor 201 proceeds to Act 208.

In Act 208, the processor 201 confirms whether a receipt display is instructed. If the result of the determination is “No” because the button B22 is not touched, the processor 201 proceeds to Act 209.

In Act 209, the processor 201 confirms whether a nutrition data display is instructed. If the result of the determination is “No” because the button B23 is not touched, the processor 201 proceeds to Act 210.

In Act 210, the processor 201 confirms whether another operation other than the instruction of the receipt display or the nutrition data display is carried out. If the result of the determination is “No” because the operation is not carried out, the processor 201 returns to Act 208.

In this way, the processor 201 waits for until the operation of instructing the receipt display or the nutrition data display or any other operation is carried out in Act 208-Act 210. Herein, if the result of the determination in Act 210 is “Yes” because another operation is carried out by the user, the processor 201 proceeds to a processing corresponding to the operation. The description of the processing for this case is omitted.

The user, in a case of wanting to browse a receipt, touches the button B22 in the top screen. If the result of the determination in Act 208 is “Yes” because the touch on the button B22 is detected by the touch panel 204, the processor 201 proceeds to Act 211.

In Act 211, the processor 201 displays a selection screen as the screen of the touch panel 204. Specifically, the processor 201 sends a receipt display request from the communication interface 205 to the receipt server 30 via the network 200. If selection screen data sent from the receipt server 30 that responds to the receipt display request is received by the communication interface 205, the processor 201 displays a selection screen as the screen of the touch panel 204 on the basis of the selection screen data.

If the receipt display request is transmitted to the receipt server 30 via the network 200, the communication interface 304 receives the receipt display request. The communication interface 304 stores the received receipt display request in the main memory 302 or the auxiliary storage device 303.

After the top screen data is transmitted in Act 305 of FIG. 15, the processor 301 proceeds to Act 306.

In Act 306, the processor 301 confirms whether the receipt display request is received. If the result of the determination is “No” because the receipt display request is not received, the processor 301 proceeds to Act 307.

In Act 307, the processor 301 confirms whether any other operation is carried out by the user. If the result of the determination is “No” because no other operation is carried out, the processor 301 returns to Act 306.

In this way, in Act 306 and Act 307, the processor 301 waits for the receiving of the receipt display request or the execution of other operation by the user. Herein, if the result of the determination in Act 307 is “Yes” because another operation is carried out by the user, the processor 301 proceeds to the processing corresponding to the operation. The description of the processing for this case is omitted.

If the result of the determination in Act 306 is “Yes” because the receipt display request is received by the communication interface 304 as stated above, the processor 301 proceeds to Act 308.

In Act 308, the processor 301 generates the selection screen data and sends the generated selection screen data from the communication interface 304 to the user terminal device 20 via the network 200.

The selection screen data indicates an image for showing that the screen of the touch panel 204 of the user terminal device 20 becomes the selection screen. The selection screen is a screen for the user to select one of the receipt data stored in the electronic receipt area W31 in association with the user code of the user who is in login process.

If the selection screen data is transmitted to the user terminal device 20 via the network 200, the communication interface 205 receives the selection screen data. The communication interface 205 stores the received selection screen data in the main memory 202 or the auxiliary storage device 203. Then, the processor 201, according to the selection screen data received through the communication interface 205 as stated above, displays the selection screen as the screen of the touch panel 204 in Act 211 of FIG. 11 as stated above. If the selection screen is displayed as the screen of the touch panel 204, the processor 201 proceeds to Act 212.

In Act 212, the processor 201 confirms whether a receipt is designated. If the result of the determination is “No” because no receipt is designated, the processor 201 proceeds to Act 213.

In Act 213, the processor 201 confirms whether the display of the top screen is instructed. If the result of the determination is “No” because the display of the top screen is not instructed, the processor 201 proceeds to Act 214.

In Act 214, the processor 201 confirms whether the display of the nutrition data is instructed. If the result of the determination is “No” because the display of the nutrition data is not instructed, the processor 201 proceeds to Act 215.

In Act 215, the processor 201 confirms whether another operation except these operations confirmed in Act 212-Act 214 is carried out. If the result of the determination is “No” because no other operation is carried out, the processor 201 returns to Act 212.

In this way, the processor 201 waits for the execution of any one of the designation of the receipt, the display instruction of the top screen, the display instruction of the nutrition data and another operation in Act 212-Act 215. Herein, if the result of the determination in Act 215 is “Yes” because another operation is carried out by the user, the processor 201 proceeds to the processing corresponding to the operation. The description of the processing for this case is omitted.

The user executes an operation in the selection screen to designate a user-desired receipt. If the result of the determination is “Yes” in Act 212 of FIG. 11 because such an operation is detected by the touch panel 204, the processor 201 proceeds to Act 216 in FIG. 12.

In Act 216, the processor 201 displays the receipt screen as the screen of the touch panel 204. Specifically, the processor 201 sends a receipt designation notification containing an electronic receipt code of the designated receipt from the communication interface 205 to the receipt server 30 via the network 200. Then, if the receipt screen data sent from the receipt server 30 that responds to the receipt designation notification is received by the communication interface 205, the processor 201 displays the receipt screen as the screen of the touch panel 204 on the basis of the receipt screen data.

If the receipt designation notification is transmitted to the receipt server 30 via the network 200, the communication interface 304 receives the receipt designation notification. The communication interface 304 stores the received receipt designation notification in the main memory 302 or the auxiliary storage device 303.

After sending the selection screen data in Act 308 of FIG. 15, the processor 301 proceeds to Act 309.

In Act 309, the processor 301 confirms whether the receipt designation notification is received. If the result of the determination is “No” because no receipt designation notification is received, the processor 301 proceeds to Act 310.

In Act 310, the processor 301 confirms whether other operation is carried out by the user. If the result of the determination is “No” because no other operation is carried out, the processor 301 returns to Act 309.

In this way, in Act 309 and Act 310, the processor 301 waits for the receiving of the receipt designation notification or the execution of other operation by the user. Herein, if the result of the determination in Act 310 is “Yes” because another operation is carried out by the user, the processor 301 proceeds to the processing corresponding to the operation. The description of the processing for this case is omitted.

If the result of the determination is “Yes” in Act 309 because the receipt designation notification is received by the communication interface 304 as stated above, the processor 301 proceeds to Act 311.

In Act 311, the processor 301 generates receipt screen data according to the receipt data specified by the electronic receipt code contained in the receipt designation notification. Then, the processor 301 sends the generated receipt screen data from the communication interface 304 to the user terminal device 20 via the network 200. The receipt screen data indicates an image showing that the screen of the touch panel 204 of the user terminal device 20 becomes the receipt screen.

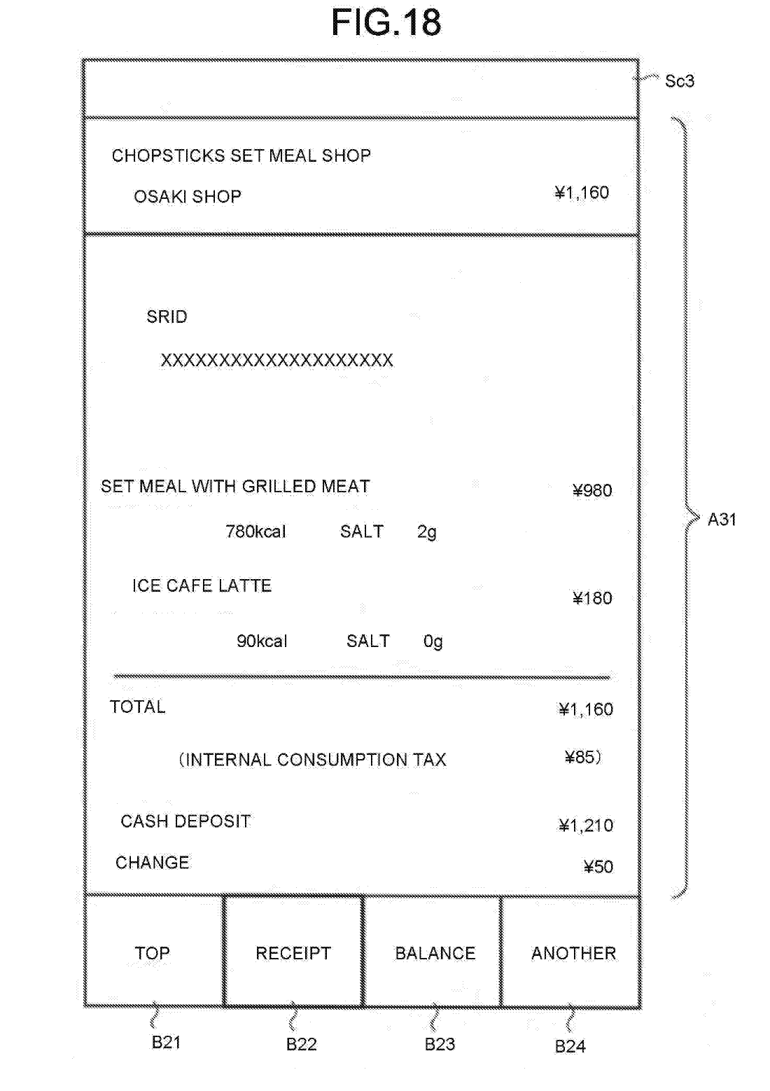

FIG. 18 is a diagram illustrating an example receipt screen Sc3. Further, display objects contained in the receipt screen Sc3 identical to that contained in the top screen Sc2 shown in FIG. 16 are applied with the same reference numerals as that shown in FIG. 16, and the detailed description is omitted.

The receipt screen Sc3 displays a receipt area A31 and the buttons B21-B24.

The receipt area A31 displays information indicating the settlement data 313 and the detail data 314 in the form of character strings.

In the receipt screen Sc3, the frame of the button B22 is thicker than that of other buttons B21, B23 and B24.

In the present embodiment, as exemplified in the receipt screen Sc3, the processor 301 displays calorie and amount of salt of each commodity in the receipt area A31. These data is not contained in the receipt data. The processor 301 acquires these data from the nutrition data server 50. Only one of the calorie and the amount of salt or other data contained in the nutrition data may be displayed in the receipt area A31. However, it is not necessary to display the nutrition data in the receipt area A31.

If the receipt screen data is transmitted to the user terminal device 20 via the network 200, the communication interface 205 receives the receipt screen data. The communication interface 205 stores the received receipt screen data in the main memory 202 or the auxiliary storage device 203. Then, the processor 201, according to the selection screen data received by the communication interface 205, displays the receipt screen as the screen of the touch panel 204 in Act 216 of FIG. 12 as stated above. If the receipt screen is displayed as the screen of the touch panel 204, the processor 201 proceeds to Act 217.

In Act 217, the processor 201 confirms whether the display of the selection screen is instructed. If the result of the determination is “No” because the display of the selection screen is not instructed, the processor 201 proceeds to Act 218.

In Act 218, the processor 201 confirms whether the display of the top screen is instructed. If the result of the determination is “No” because the display of the top screen is not instructed, the processor 201 proceeds to Act 219.

In Act 219, the processor 201 confirms whether the display of the nutrition data is instructed. If the result of the determination is “No” because the display of the nutrition data is not instructed, the processor 201 proceeds to Act 220.

In Act 220, the processor 201 confirms whether another operation other than these operations confirmed in Act 217-Act 219 is carried out. If the result of the determination is “No” because the operation is not carried out, the processor 201 returns to Act 217.

In this way, the processor 201, in Act 217-Act 220, waits for the execution of any one of the display instruction of the selection screen, the display instruction of the top screen, the display instruction of the nutrition data and other operation. Herein, if the result of the determination in Act 220 is “Yes” because another operation is carried out by the user, the processor 201 proceeds to the processing corresponding to the operation. The description of the processing for this case is omitted.

On the other hand, after sending the receipt screen data in Act 311 of FIG. 15, the processor 301 proceeds to Act 312. Thus, when the processor 201 is in the wait state in Act 217-Act 220 of FIG. 12, the processor 301 is in the wait state in Act 312-Act 314 of FIG. 15.

In Act 312, the processor 301 confirms whether the display of the receipt screen is requested. If the result of the determination is “No” because the display of the receipt screen is not requested, the processor 301 proceeds to Act 313.

In Act 313, the processor 301 confirms whether the display of the top screen is requested. If the result of the determination is “No” because the display of the top screen is not requested, the processor 301 proceeds to Act 314.

In Act 314, the processor 301 confirms whether another operation other than these operations confirmed in Act 312 and Act 313 is carried out. If the result of the determination is “No” because the operation is not carried out, the processor 301 returns to Act 312.

In this way, the processor 301, in the wait state of Act 312-Act 314, waits for the execution of any one of the display request of the receipt screen, the display request of the top screen and other operation. Herein, if the result of the determination in Act 314 is “Yes” because another operation is carried out by the user, the processor 301 proceeds to the processing corresponding to the operation. The description of the processing for this case is omitted.

The user, in a case of hoping to change the displayed receipt, touches the button B22 in the receipt screen. If the result of the determination in Act 217 is “Yes” because the touch on the button B22 is detected by the touch panel 204, the processor 201 returns to Act 211 in FIG. 11 and repeats the processing thereafter similarly to that described above. Therefore, the receipt display request is sent from the user terminal device 20 to the receipt server 30 via the network 200.

If the receipt display request is transmitted to the receipt server 30 via the network 200, the communication interface 304 receives the receipt display request. The communication interface 304 stores the received receipt display request in the main memory 302 or the auxiliary storage device 303. If the result of the determination in Act 312 is “Yes” because the receipt display request is received, the processor 301 returns to Act 308 and repeats the processing thereafter similarly to that described above.

In this way, similarly to that described above, the screen of the touch panel 204 is switched to the selection screen.

The user, in a case of hoping to return the screen to the top screen, touches the button B21 in the receipt screen. If the result of the determination in Act 218 is “Yes” because the touch on the button B21 is detected by the touch panel 204, the processor 201 returns to Act 207 in FIG. 11 and repeats the processing thereafter similarly to that described above. Thus, a top display request is sent from the user terminal device 20 to the receipt server 30 via the network 200.

If the top display request is transmitted to the receipt server 30 via the network 200, the communication interface 304 receives the receipt display request. The communication interface 304 stores the received top display request in the main memory 302 or the auxiliary storage device 303. If the result of the determination in Act 313 is “Yes” because the top display request is received as stated above, the processor 301 returns to Act 305 and repeats the processing thereafter similarly to that described above.

In this way, similarly to that described above, the screen of the touch panel 204 is switched to the top screen.

The user, in a case of hoping to confirm the distribution of the ingested nutrition and the calories, touches the button B23 in the receipt screen. If the result of the determination in Act 219 is “Yes” because the touch on the button B23 is detected by the touch panel 204, the processor 201 proceeds to Act 221.

In Act 221, the processor 201 activates a processing based on the health application P22 as a processing of another task.

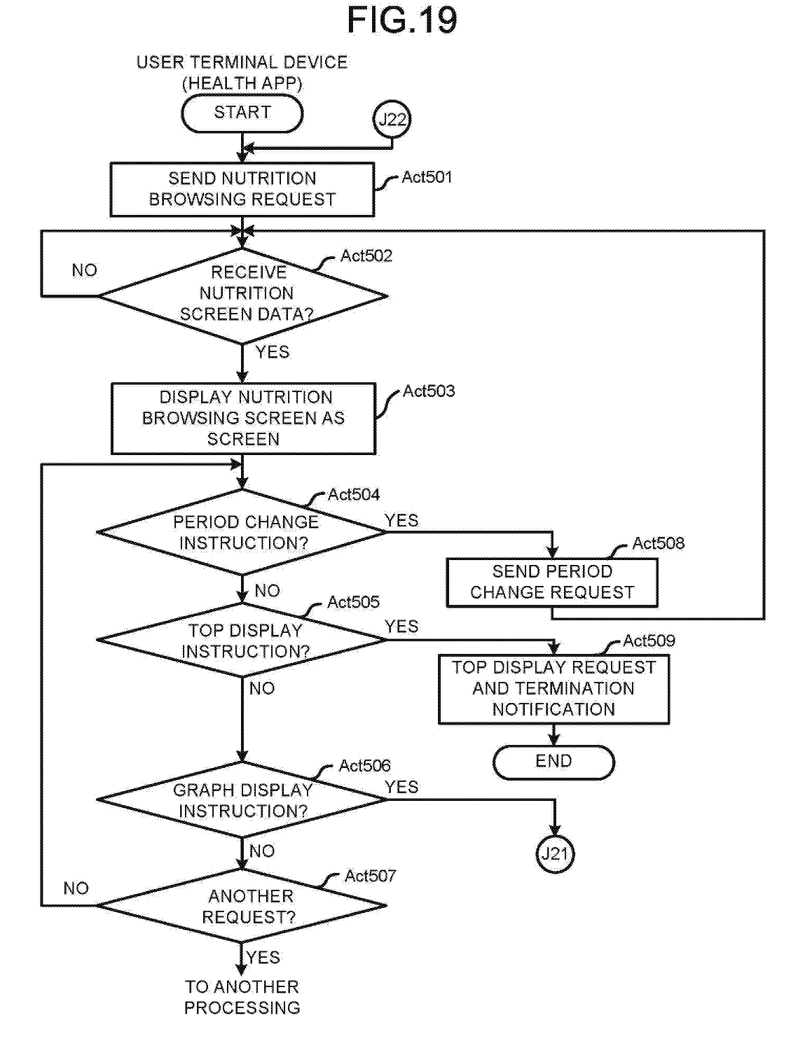

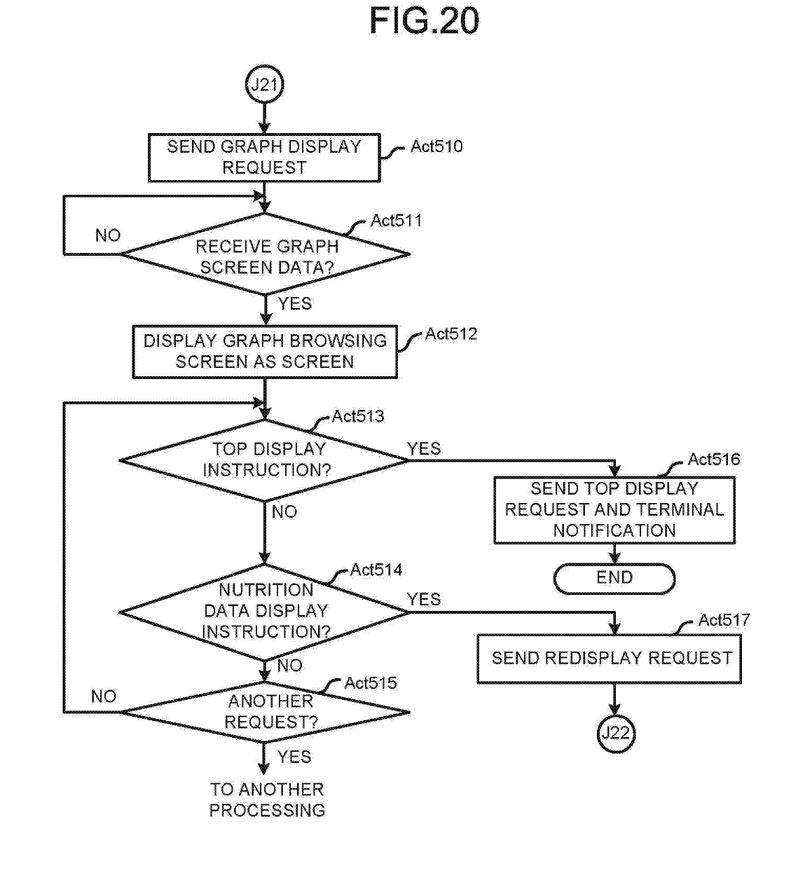

FIG. 19 and FIG. 20 are flowcharts of processing of the processor 201 based on the health application P22 of the user terminal device 20.

In Act 501 of FIG. 19, the processor 201 sends a nutrition browsing request from the communication interface 205 to the browsing server 40 via the network 200. The processor 201 makes the user code contained in the top screen data stored in the main memory 202 or the auxiliary storage device 203 stored in the nutrition browsing request.

If the nutrition browsing request is transmitted to the browsing server 40 via the network 200, the communication interface 404 receives the nutrition browsing request. The communication interface 404 stores the received nutrition browsing request in the main memory 402 or the auxiliary storage device 403.

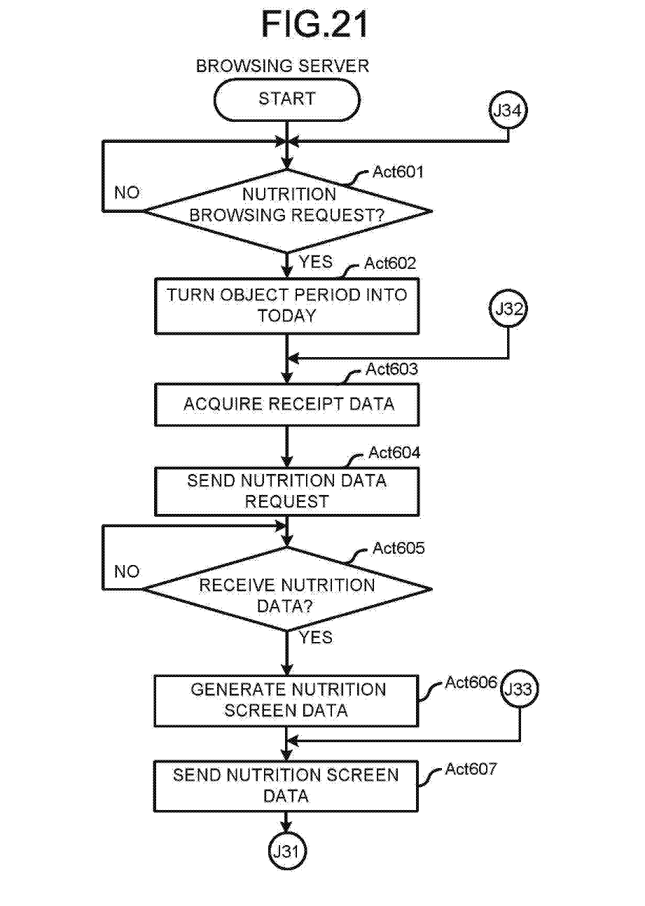

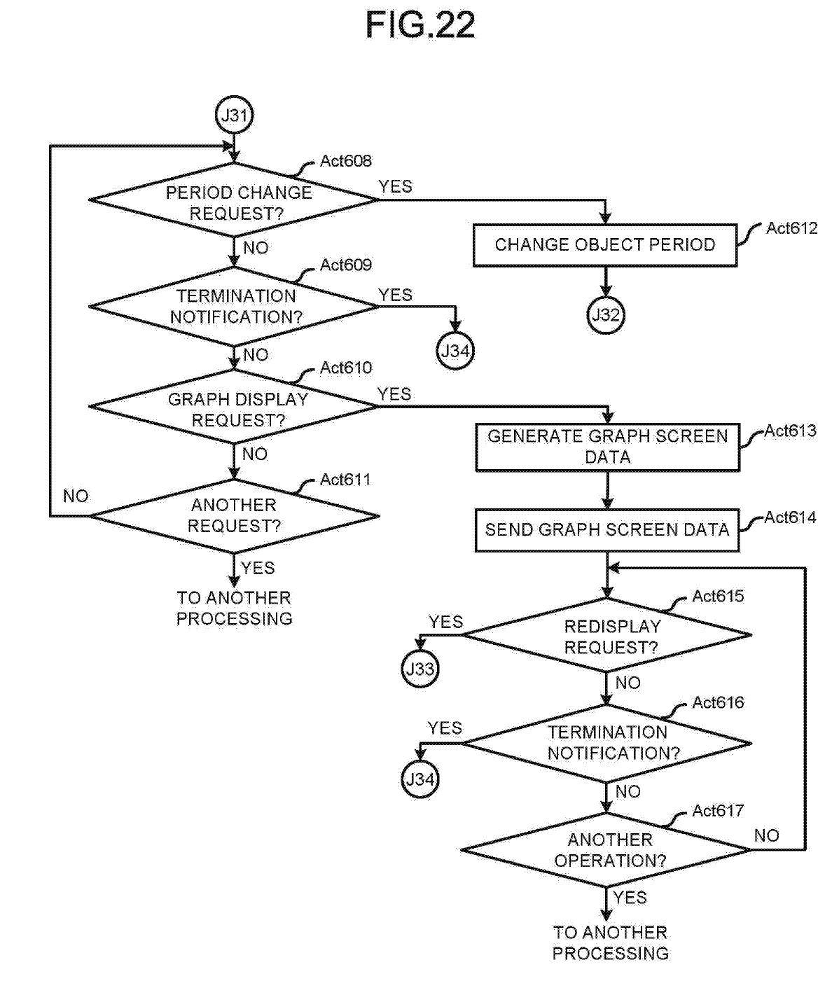

FIG. 21 and FIG. 22 are flowcharts of processing of the processor 401 based on browsing server application P41 of the browsing server 40.

In Act 601, the processor 401 confirms whether the nutrition browsing request is received. If the result of the determination is “No” because the nutrition browsing request is not received, the processor 401 repeats Act 601. In this way, the processor 401, in Act 601, waits for the receiving of the nutrition browsing request. If the result of the determination is “Yes” because the nutrition browsing request is received by the communication interface 404 as stated above, the processor 401 proceeds to Act 602.

In Act 602, the processor 401 sets the object period to “the whole day of today”.

In Act 603, the processor 401 accesses the receipt server 30 to acquire receipt data, from the receipt data stored in the electronic receipt area W31 in association with the user code, which includes the time information indicating the settlement date and time within the object period and the user code corresponding to the user code contained in the nutrition browsing request. The processor 401 stores the acquired receipt data in the main memory 402 or the auxiliary storage device 403. In this way, through the execution of the control processing based on the browsing server application P41 by the processor 401, the computer taking the processor 401 as the main unit functions as a selection module.

In Act 604, the processor 401 sends a nutrition data request from the communication interface 404 to the nutrition data server 50 via the network 200. The processor 401 makes the object period, and key data composed of the combination of each store code in the foregoing acquired receipt data with each commodity code in the same receipt data contained in the nutrition data request.

If the nutrition data request is transmitted to the nutrition data server 50 via the network 200, the communication interface 504 receives the nutrition data request. The communication interface 504 stores the received nutrition data request in the main memory 502 or the auxiliary storage device 503.

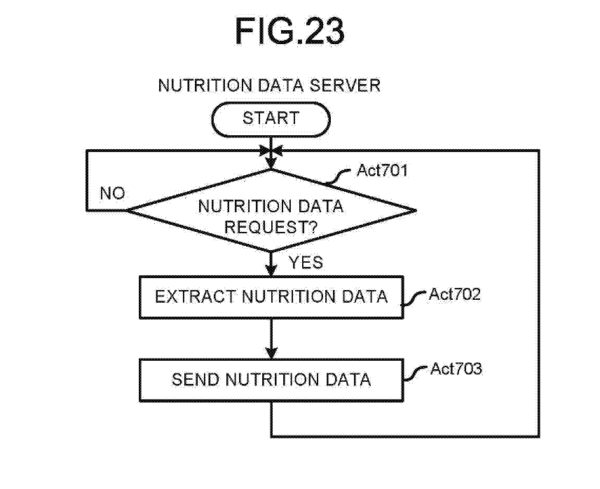

FIG. 23 is a flowchart of processing of the processor 501 based on the nutrition data server application P51 of the nutrition data server 50.

In Act 701, the processor 501 confirms whether the nutrition data request is received. If the result of the determination is “No” because the nutrition data request is not received by the communication interface 504 as stated above, the processor 501 repeats Act 701. In this way, in Act 701, the processor 501 waits for the receiving of the nutrition data request. If the result of the determination is “Yes” because the nutrition data request is received by the communication interface 504 as stated above, the processor 501 proceeds to Act 702.

In Act 702, the processor 501 extracts necessary nutrition data from the nutrition data stored in the nutrition data area W51 of the auxiliary storage device 503. The extraction object herein, relating to each key data contained in the nutrition data request, is nutrition data coinciding with the combination of the store code 511 with the commodity code 512 in the key data.

In Act 703, the processor 501 sends the foregoing extracted nutrition data to the browsing server 40. Specifically, the processor 501 generates the transmission file containing all the nutrition data extracted in Act 702. The processor 501 sends the foregoing transmission file from the communication interface 504 to the browsing server 40 via the network 200. Afterwards, the processor 501 returns to the wait state in Act 701.

If the transmission file containing the nutrition data is transmitted to the browsing server 40 via the network 200, the communication interface 404 receives the transmission file. The communication interface 404 stores the received transmission file in the main memory 402 or the auxiliary storage device 403.

After sending the nutrition data request in Act 604 of FIG. 21, the processor 401 proceeds to Act 605.

In Act 605, the processor 401 confirms whether the nutrition data is received. If the result of the determination is “No” because the transmission file containing the nutrition data is not received, the processor 401 repeats Act 605.

In this way, in Act 605, the processor 401 waits for the receiving of the nutrition data. If the result of the determination in Act 605 is “Yes” because the transmission file containing the nutrition data is received by the communication interface 404 as stated above, the processor 401 proceeds to Act 606.

In Act 606, the processor 401 generates the nutrition screen data in the browsing image area W41 of the auxiliary storage device 403.

The nutrition screen data indicates a browsing image showing that the screen of the touch panel 204 of the user terminal device 20 becomes the nutrition browsing screen. In this way, through the execution of the control processing based on the browsing server application P41 by the processor 401, the computer taking the processor 401 as the main unit functions as a second generation module.

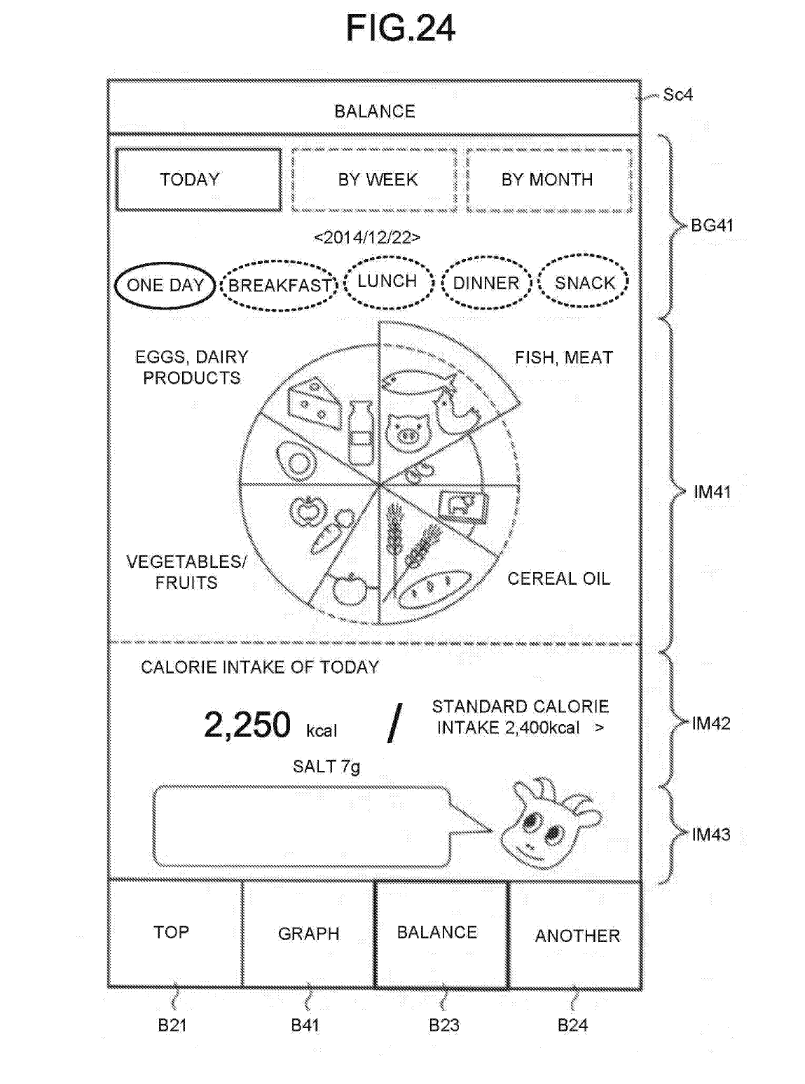

FIG. 24 is a diagram illustrating a nutrition browsing screen Sc4 as an example. Further, the display objects contained in the nutrition browsing screen Sc4 identical to that contained in the top screen Sc2 shown in FIG. 16 are applied with the same reference numerals as that shown in FIG. 16, and the detailed description is omitted.

The nutrition browsing screen Sc4 displays a button group BG41, images IM41, IM42 and IM43 and buttons B21, B23, B24 and B41.

The button group BG41 includes a plurality of buttons touched by the user to change object period. For example, buttons indicated by a character “today”, “by week” or “by months” represent a period of a day or longer and buttons indicated by a character “one day”, “breakfast”, “lunch”, “dinner” or “snack” represent a specific time or event. The button group BG41 has an indicator function for indicating the setting status of the current object period. In the button group BG41, by displaying a button indicated by a character “today” and a button indicated by a character “one day” with thick frames, it is indicated that the object period is set to be the whole day of today.

The image IM41 indicates the balance of the nutrients ingested during the object period.

The image IM42 indicates the calories ingested during the object period.

The image IM43 indicates supplementary information coinciding with predetermined conditions. However, in FIG. 24, the supplementary information supposed to be displayed in the image IM43 is not shown.

The button B41 is touched by the user to instruct the switch to a graph screen.

The processor 401, for example, copies or decompresses images of the button group stored previously in the auxiliary storage device 403 in a predetermined area in the browsing image area W41 as images in which the frame border of each button becomes the dotted line. Further, the processor 401 makes the frame borders of a part of buttons become thick lines to indicate the object period shown in the nutrition browsing request.

The processor 401, for example, adds up points shown in the nutritional balance data 514 contained in each of the nutrition data contained in the transmission file for each nutrient to calculate total points of each nutrient. Then, the processor 401 generates an image IM41 shown in FIG. 24 indicating the balance of the total points of each nutrient and copies or decompresses the generated image IM41 in a predetermined area in the browsing image area W41.

The processor 401, for example, adds up the calories shown in the calorie data 513 contained in each of nutrition data contained in the transmission file to calculate total calories. Then, the processor 401 generates an image IM42 shown in FIG. 24 indicating the total calories and copies or decompresses the generated image IM42 in a predetermined area in the browsing image area W41.

The processor 401, for example, generates an image IM43 according to the predetermined condition and copies or decompresses the generated image IM43 in a predetermined area in the browsing image area W41.

In Act 607, the processor 401 sends the nutrition screen data stored in the browsing image area W41 from the communication interface 404 to the user terminal device 20 via the network 200.

If the nutrition screen data is transmitted to the user terminal device 20 via the network 200, the communication interface 205 receives the nutrition screen data. The communication interface 205 stores the received transmission file in the main memory 202 or the auxiliary storage device 203.

After sending the nutrition browsing request in Act 501 of FIG. 19, the processor 201 proceeds to Act 502.

In Act 502, the processor 201 confirms whether the nutrition screen data is received. If the result of the determination is “No” because the nutrition screen data is not received, the processor 201 repeats Act 502.

In this way, in Act 502, the processor 201 waits for the receiving of the nutrition screen data. If the result of the determination in Act 502 is “Yes” because the nutrition screen data is received through the communication interface 205 as stated above, the processor 201 proceeds to Act 503.

In Act 503, the processor 201 displays the nutrition browsing screen indicating nutrition screen data as the screen of the touch panel 204. In this way, through the execution of the control processing based on the health application P22 by the processor 201, the computer taking the processor 201 as the main unit functions as a presentation module.

In Act 504, the processor 201 confirms whether the change of the object period is instructed. If the result of the determination is “No” because the change of the object period is not instructed, the processor 201 proceeds to Act 505.

In Act 505, the processor 201 confirms whether the display of the top screen is instructed. If the result of the determination is “No” because the display of the top screen is not instructed, the processor 201 proceeds to Act 506.

In Act 506, the processor 201 confirms whether the display of a graph is instructed. If the result of the determination is “No” because the display of the graph is not instructed, the processor 201 proceeds to Act 507.

In Act 507, the processor 201 confirms whether another operation other than these operations conformed in Act 504-Act 506 is carried out. If the result of the determination is “No” because no other operation is carried out, the processor 201 returns to Act 504.

In this way, the processor 201, in Act 504-Act 507, waits for the execution of any one of the change instruction of the object period, the display instruction of the top screen, the display instruction of the graph, and another operation. Herein, if the result of the determination in Act 507 is “Yes” because another operation is carried out by the user, the processor 201 proceeds to a processing corresponding to the operation. The description of the processing for this case is omitted.

The user, in a case of hoping to change the object period, carries out an operation on the nutrition browsing screen. If the result of the determination in Act 504 is “Yes” because the operation of instructing the change of the object period is carried out, the processor 201 proceeds to Act 508.

The processor 201 inputs the touch on a button whose frame border is dotted line among the button group on the nutrition browsing screen as the instruction of changing the object period. For example, if a button indicated by a character “dinner” on the nutrition browsing screen Sc4 is touched, the processor 201 inputs the touch on the button as an instruction of changing the object period into the dinner period of today. For example, if a button indicated by a character “by week” or “by months” on the nutrition browsing screen Sc4 is touched, the processor 201 inputs the touch on the button as an instruction of changing the object period into the past week or month containing today.

Alternatively, the processor 201 inputs an operation of flicking the inside of the screen of the touch panel 204 in the left direction or right direction as the instruction of changing date. For example, the nutrition browsing screen Sc4 is an example of the nutrition browsing screen on Dec. 22, 2014. If an operation of flicking the inside of the nutrition browsing screen Sc4 in the left direction is detected by the touch panel 204, the processor 201 inputs the flicking operation as an instruction of changing the object period to a whole day of Dec. 21, 2014. Further, if an operation of flicking the inside of the nutrition browsing screen on which the past is the object period in the right direction is detected by the touch panel 204, the processor 201 inputs the flicking operation as an instruction of changing the object period to next day.

The processor 201, in a case in which each button contained in the button group BG41 is touched, may determine to set what kind of object period with reference to setting data that depicts the period, in association with each button. The setting data, for example, is stored in the auxiliary storage device 203. The setting data, regardless of the user, for example, may use data created by the creator of the receipt client application P21 in common. However, time zones of ingesting meal differ according to different life-style of each user. Thus, the processor 201 may change the depiction of the setting data in response to the instruction of the user.

In Act 508, the processor 201 sends a period change request indicating the content of the instruction of changing the object period from the communication interface 205 to the browsing server 40 via the network 200. In this way, through the execution of the control processing based on the health application P22 by the processor 201, the computer taking the processor 201 as the main unit functions as a setting module.

If the period change request is transmitted to the browsing server 40 via the network 200, the communication interface 404 receives the period change request. The communication interface 404 stores the received period change request in the main memory 402 or the auxiliary storage device 403.

After sending the nutrition screen data in Act 607 of FIG. 21, the processor 401 proceeds to Act 608 of FIG. 22.

In Act 608, the processor 401 confirms whether the change of the object period is requested. If the result of the determination is “No” because the change of the object period is not requested, the processor 401 proceeds to Act 609.

In Act 609, the processor 401 confirms whether a termination notification is made. If the result of the determination is “No” because no termination notification is made, the processor 401 proceeds to Act 610.

In Act 610, the processor 401 confirms whether the display of the graph is requested. If the result of the determination is “No” because the display of the graph is not requested, the processor 401 proceeds to Act 611.

In Act 611, the processor 401 confirms whether another operation other than these operations confirmed in Act 608-Act 610 is carried out. If the result of the determination is “No” because no other operation is carried out, the processor 401 returns to Act 608.

In this way, the processor 401, in Act 608-Act 611, waits for the execution of any one of the change request of the object period, the termination notification, the display request of the graph and another operation. Herein, if the result of the determination in Act 611 is “Yes” because another operation is carried out by the user, the processor 401 proceeds to the processing corresponding to the operation. The description of the processing for this case is omitted.

If the result of the determination in Act 608 is “Yes” because the period change request is received as stated above, the processor 401 proceeds to Act 612.

In Act 612, the processor 401 changes the object period in response to the content of the instruction shown in the received period change request. Afterwards, the processor 401 returns to Act 603 in FIG. 21 and repeats the processing thereafter similarly to that described above. In this way, the receipt data the settlement date and time in which is within the changed object period is acquired again, and nutrition screen data based on the receipt data is re-created.

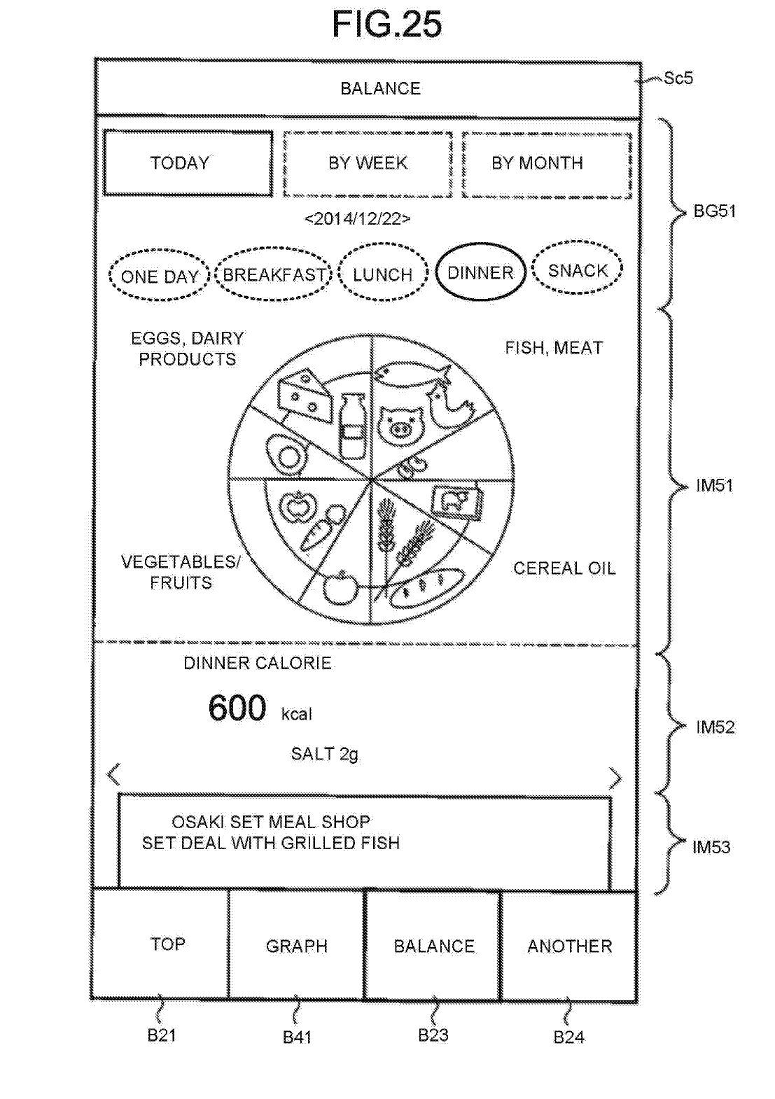

FIG. 25 is a diagram illustrating a nutrition browsing screen Sc5 as an example. Further, the display objects contained in the nutrition browsing screen Sc5 identical to that contained in the top screen Sc2 and the nutrition browsing screen Sc4 shown in FIG. 16 and FIG. 24 are applied with the same reference numerals as that shown in FIG. 16 and FIG. 24, and the detailed description is omitted.

The nutrition browsing screen Sc5 is an example of the nutrition browsing screen re-created in a case in which the button indicated by the character “dinner” in the button group BG41 of the nutrition browsing screen Sc4 shown in FIG. 24 is touched.

The nutrition browsing screen Sc5 displays a button group BG51, images IM51, IM52 and IM53 and buttons B21, B23, B24 and B41.

The button group BG51 is different from the button group BG41 shown in FIG. 24 in that the frame border of the button indicated by the character “one day” becomes the dotted line and the frame border of the button indicated by the character “dinner” becomes the thick line.

The image IM51 indicates the balance of the ingested nutrients in the dinner of today.

The image IM52 indicates the calories ingested in the dinner of today.

The image IM53 indicates a store name and a commodity name shown in the re-acquired receipt data.

The user, in a case of hoping to return the screen from the nutrition browsing screen to the top screen, touches the button B21 in the nutrition browsing screen. If the result of the determination in Act 505 of FIG. 19 is “Yes” because the touch on the button B21 is detected by the touch panel 204, the processor 201 proceeds to Act 509.

In Act 509, the processor 201 requests a top display for the processing based on the receipt client application P21. Further, the processor 201 sends the termination notification from the communication interface 205 to the browsing server 40 via the network 200. Then, the processor 201 terminates the processing based on the health application P22.

The processor 201, in the processing based on the receipt client application P21, after activating the processing based on the health application in Act 221 of FIG. 12, proceeds to Act 222.

In Act 222, the processor 201 confirms whether the top display is requested. If the result of the determination is “No” because the top display is not requested, the processor 201 repeats Act 222.

In this way, the processor 201 waits for until the top display is requested in Act 222. If the result of the determination is “Yes” in Act 222 because the top display is requested by the processing in Act 509 as stated above, the processor 201 returns to Act 207 in FIG. 11 and repeats the processing thereafter similarly to that described above. In this way, the screen of the touch panel 204 returns to the top screen.

On the other hand, in Act 509, if the termination notification sent from the user terminal device 20 is transmitted to the browsing server 40 via the network 200, the communication interface 404 receives the termination notification. The communication interface 404 notifies the processor 401 of the reception of the termination notification. At this time, the processor 401 is in the wait state of Act 608-Act 611 in FIG. 22. Thus, the processor 401 determines the result in Act 609 is “Yes” because the termination notification is received as stated above. Then, in this case, the processor 401 returns to the wait state in Act 601.

The user, in a case of hoping to change the screen from the nutrition browsing screen to the graph screen, touches the button B41 in the nutrition browsing screen. If the result of the determination in Act 506 of FIG. 19 is “Yes” because the touch on the button B41 is detected by the touch panel 204, the processor 201 proceeds to Act 510 of FIG. 20.

In Act 510, the processor 201 sends a graph display request from the communication interface 205 to the browsing server 40 via the network 200. At this time, the processor 201 acquires the data of activity amount relating to a predetermined graph period from the activity meter 300 via the wireless interface 206 and makes the data of activity amount included in the graph display request. The graph period is optional or is determined by, for example, the creator of the health application P22 or the user. This period is assumed to be a period, for example, from one week before up to today.

The activity meter 300 measures a value relating to the activity amount of the user regularly and stores the data of activity amount indicating the numerical value in time series. That the data of activity amount contains numerical values of what kind of items is optional; however, in the present embodiment, it is assumed that the calorie consumption and the number of steps are contained.

If the graph display request is transmitted to the browsing server 40 via the network 200, the communication interface 404 receives the graph display request. The communication interface 404 stores the received graph display request in the main memory 402 or the auxiliary storage device 403.

At this time, the processor 401 is in the wait state of Act 608-Act 611 in FIG. 22. If the result of the determination in Act 610 is “Yes” because the graph display request is received by the communication interface 404 as stated above, the processor 401 proceeds to Act 613.

In Act 613, the processor 401 generates ingestion screen data in the browsing image area W41 of the auxiliary storage device 403.

The graph screen data is data for switching the screen of the touch panel 204 to a graph browsing screen containing graphs of state of change of the calorie intake and the calorie consumption every day.

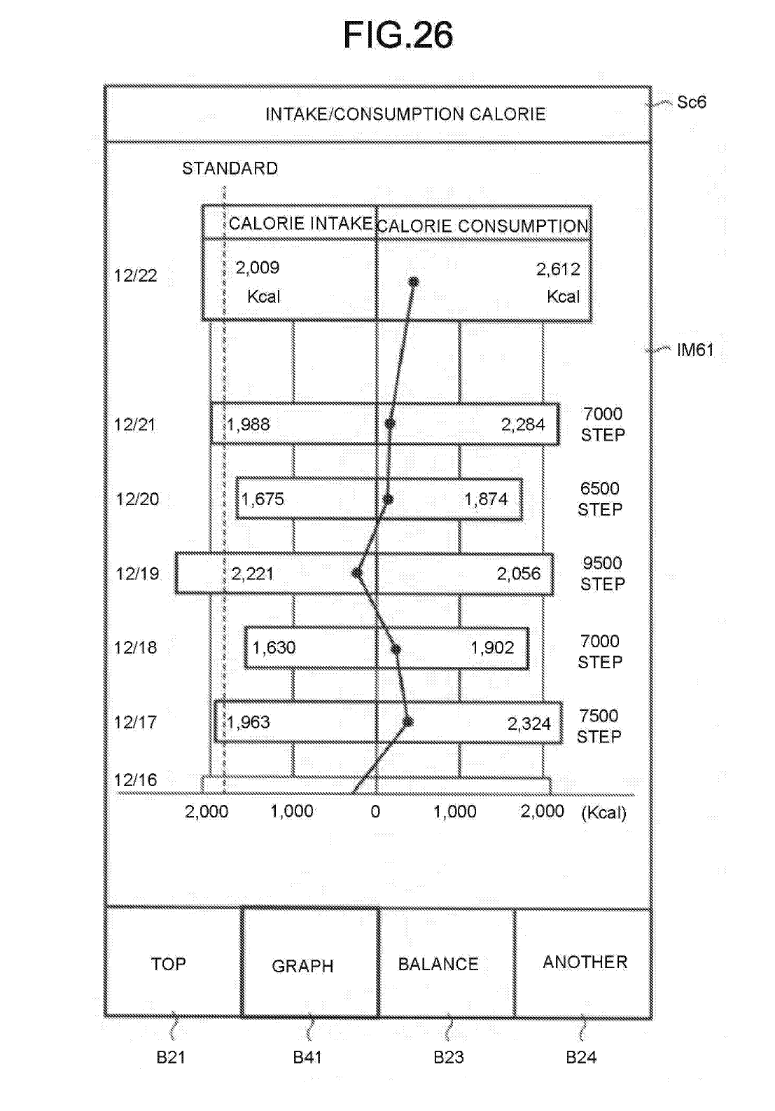

FIG. 26 is a diagram illustrating a graph browsing screen Sc6 as an example. Further, the display objects contained in the graph browsing screen Sc6 identical to that contained in the top screen Sc2 and the nutrition browsing screen Sc4 shown in FIG. 16 and FIG. 24 are applied with the same reference numerals as that shown in FIG. 16 and FIG. 24, and the detailed description is omitted.

The graph browsing screen Sc6 displays an image IM61 and buttons B21, B23, B24 and B41.

The image IM61 displays a first bar graph indicating the change of the daily calorie intake, a second bar graph indicating the change of the daily calorie consumption, a polygonal line graph indicating the difference between the daily calorie intake and the daily calorie consumption and the daily number of steps.

The processor 401 accesses the receipt server 30 to acquire the receipt data the settlement date and time in which is within the graph period from the receipt data stored in the electronic receipt area W31 in association with the user code. Further, the processor 401 accesses the nutrition data server 50 to acquire nutrition data relating to the commodity specified by the store code and the commodity code contained in the foregoing acquired receipt data. The processor 401 stores the acquired receipt data and nutrition data in the main memory 402 or the auxiliary storage device 403.

Then, the processor 401, on the basis of the receipt data, the nutrition data and the graph display request stored in the main memory 402 or the auxiliary storage device 403, copies or decompresses images respectively indicating each graph and the number of steps in the browsing image area W41. The processor 401, in this way, generates the graph screen data inside the browsing image area W41. However, the processor 401 generates the graph screen data in an area other than the area in which the nutrition screen data is already stored inside the browsing image area W41, and the nutrition screen data is stored inside the browsing image area W41 in advance as it is.

In Act 614, the processor 401 sends the graph screen data stored in the browsing image area W41 from the communication interface 404 to the user terminal device 20 via the network 200.

If the graph screen data is transmitted to the user terminal device 20 via the network 200, the communication interface 205 receives the graph screen data. The communication interface 205 stores the received transmission file containing the graph screen data in the main memory 202 or the auxiliary storage device 203.

After sending the graph display request in Act 510 of FIG. 20, the processor 201 proceeds to Act 511.

In Act 511, the processor 201 confirms whether the graph screen data is received. If the result of the determination is “No” because no graph screen data is received, the processor 201 repeats Act 511.

In this way, in Act 511, the processor 201 waits for the receiving of the graph screen data. If the result of the determination in Act 511 is “Yes” because the graph screen data is received by the communication interface 205 as stated above, the processor 201 proceeds to Act 512.

In Act 512, the processor 201 displays the graph browsing screen indicated by the graph screen data as the screen of the touch panel 204.

In Act 513, the processor 201 confirms whether the display of the top screen is instructed. If the result of the determination is “No” because the display of the top screen is not instructed, the processor 201 proceeds to Act 514.

In Act 514, the processor 201 confirms whether the display of the nutrition data is instructed. If the result of the determination is “No” because the display of the nutrition data is not instructed, the processor 201 proceeds to Act 515.

In Act 515, the processor 201 confirms whether or not another operation other than these operations confirmed in Act 513 and Act 514 is carried out. If the result of the determination is “No” because no other operation is carried out, the processor 201 returns to Act 513.

In this way, the processor 201, in Act 513-Act 515, waits for the execution of any one of the display instruction of the top screen, the display instruction of the nutrition data and another operation. Herein, if the result of the determination in Act 515 is “Yes” because another operation is carried out by the user, the processor 201 proceeds to the processing corresponding to the operation. The description of the processing for this case is omitted.

The processor 201, in the wait state of Act 513-Act 515, may return to Act 510 according to the occurrence of a case in which the elapsed time after the graph browsing screen is displayed because the screen of the touch panel 204 reaches a predetermined time (e.g. one minute) in Act 512. In this way, a graph browsing screen based on the latest data of activity amount can be always displayed as the screen of the touch panel 204.

On the other hand, after sending the graph screen data in Act 614 of FIG. 22, the processor 401 proceeds to Act 615. Thus, when the processor 201 is in the wait state of Act 513-Act 515, the processor 401 is in the wait state of Act 615-Act 617 in FIG. 22 as well.

In Act 615, the processor 401 confirms whether the redisplay of the nutrition data is requested. If the result of the determination is “No” because no redisplay of the nutrition data is requested, the processor 401 proceeds to Act 616.

In Act 616, the processor 401 confirms whether the termination notification is made. If the result of the determination is “No” because no termination notification is made, the processor 401 proceeds to Act 617.

In Act 617, the processor 401 confirms whether another operation other than these operations confirmed in Act 615 and Act 616 is carried out. If the result of the determination is “No” because no other operation is carried out, the processor 401 returns to Act 615.

In this way, the processor 401, in the wait state of Act 615-Act 617, waits for the execution of any one of the redisplay request of the nutrition data, the termination notification and another operation. Herein, if the result of the determination in Act 617 is “Yes” because another operation is carried out by the user, the processor 401 proceeds to the processing corresponding to the operation. The description of the processing for this case is omitted.

The user, in a case of hoping to return the screen from the graph browsing screen to the top screen, touches the button B21 in the graph browsing screen. If the result of the determination is “Yes” in Act 513 of FIG. 20 because the touch on the button B21 is detected by the touch panel 204, the processor 201 proceeds to Act 516.

In Act 516, the processor 201 requests the top display for the processing based on the receipt client application P21. Further, the processor 201 sends the termination notification from the communication interface 205 to the browsing server 40 via the network 200. Then the processor 201 terminates the processing based on the health application P22. At this time, the processor 201 is in the wait state in Act 222 of FIG. 12 in the processing based on the receipt client application P21. Thus, the processor 201 receives the foregoing termination notification to determine that the result of the determination in Act 222 is “Yes”, and returns to Act 207 in FIG. 11.

If the termination notification is transmitted to the browsing server 40 via the network 200, the communication interface 404 receives the termination notification and notifies the processor 401 of the reception of the termination notification. If the result of the determination in Act 616 is “Yes” because the termination notification is received, the processor 401 returns to the wait state in Act 601 of FIG. 21.

The user, in a case of hoping to return the screen from the graph browsing screen to the nutrition browsing screen, touches the button B23 in the graph browsing screen. If the result of the determination in Act 514 of FIG. 20 is “Yes” because the touch on the button B23 is detected by the touch panel 204, the processor 201 proceeds to Act 517.

In Act 517, the processor 201 sends a redisplay request from the communication interface 205 to the browsing server 40 via the network 200.

If the redisplay request is transmitted to the browsing server 40 via the network 200, the communication interface 404 receives the redisplay request and notifies the processor 401 of the reception of the redisplay request. If the result of the determination in Act 615 of FIG. 22 is “Yes” because the notification of the redisplay request is received, the processor 401 returns to Act 607 and repeats the processing thereafter similarly to that described above. However, at this time, the processor 401 resends the nutrition screen data stored in the browsing image area W41. In this way, the screen of the touch panel 204 is returned to the nutrition browsing screen prior to the graph browsing screen from the graph browsing screen.

In this way, according to the nutrition information system 100, the user can easily confirm the nutrition data such as the nutritional balance and the calorie relating to the ingested foods and drinks from the information presented as the nutrition browsing screen through the user terminal device 20.

Then, the nutrition information system 100 obtains the nutrition data according to the receipt data. Therefore, it is not necessary for the user to carry out the operation of inputting information relating to the foods and drinks.

The nutrition information system 100 selects the receipt data in which the settlement date and time is within the object period and obtains the nutrition data according to the selected receipt data. As the settlement relating to the meal at the restaurant is carried out usually before or after the meal, the date and time when the settlement is carried out is not largely different from the date and time of the meal. Thus, substantially, it may be considered to present the nutritional balance and the calorie of the meal in the object period. Therefore, the user can identify that what kind of nutritional balance and calorie are ingested at what kind of period.

Further, the nutrition information system 100 changes the object period according to the instruction of the user. Thus, the user can confirm the nutritional balance and the calorie at any period.

The embodiment may have various modifications as follows.

The processor 401 receives the designation of a period from the user in a form such as “17:00-21:00” and may set the period as the object period.

The receipt server 30 and the browsing server 40 may be replaced by a server which is simultaneously equipped with their functions.

The browsing server 40 and the nutrition data server 50 may be replaced by a server which is simultaneously equipped with their functions.

The receipt server 30, the browsing server 40 and the nutrition data server 50 may be replaced by a server which is simultaneously equipped with their functions.

The screen data for displaying various screens as the screen of the touch panel 204 may be generated by the processor 201.

The browsing screen may be presented by an image display on a display device except the touch panel 204 or by other methods such as a printing.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A server for providing nutrition data to a user comprising:
a communication interface;
a memory; and
a processor configured to control the communication interface and the memory to:
receive from a user device a request for nutrition information of food and drink purchased by the user, the request including user identification relating to the purchase of the food and drink,
determine a time period of the requested nutrition information,
retrieve from a first storage device, based on the user identification in the request, receipt data corresponding to the user identification and the determined time period, the receipt data including a first data for identifying the food and drink purchased by the user,
retrieve from a second storage device, based on the first data, nutrition data corresponding to the foods and drink purchased by the user, and
generate and send to the user device an image data that includes the nutrition data.

2. The server according to claim 1, wherein the first storage device is included in a separate store server.

3. The server according to claim 1, wherein the second storage device is included in a separate nutrition data server.

4. The server according to claim 1, wherein the nutrition data represent at least one of distribution of each of plural nutrients and total calories of the food and drink purchased by the user.

5. The server according to claim 1, wherein the processor is further configured to control the memory and interface to store the nutrition data in association with an identification code of the user.

6. The server according to claim 1, wherein the processor determines the time period of the requested nutrition information based on one of a default time period and a selected time period included in the request for nutrition information of food and drink purchased by the user.

7. The server according to claim 6, wherein the processor is further configured to control the memory and interface to store the nutrition data in association with the determined time period.

8. A method of providing nutrition data to a user comprising the steps of:
receiving, in a server, a request from a user device for nutrition information of food and drink purchased by the user, the request including user identification relating to the purchase of the food and drink;
determining a time period of the requested nutrition information;
retrieving from a first storage device, based on the user identification in the request, receipt data corresponding to the user identification and the determined time period, the receipt data including a first data for identifying the food and drink purchased by the user;
retrieving from a second storage device, based on the first data, nutrition data corresponding to the foods and drink purchased by the user; and
generating, in the server, and sending to the user device an image data that includes the nutrition data.

9. The method according to claim 8, wherein the first storage device is included in a separate store server.

10. The method according to claim 8, wherein the second storage device is included in a separate nutrition data server.

11. The method according to claim 8, wherein the nutrition data represent at least one of distribution of each of plural nutrients and total calories of the food and drink purchased by the user.

12. The method according to claim 8, further comprising the step of:
controlling the memory and interface to store the nutrition data in association with an identification code of the user.

13. The method according to claim 8, wherein the time period of the requested nutrition information is determined based on one of a default time period and a selected time period included in the request for nutrition information of food and drink purchased by the user.

14. The method according to claim 13, further comprising:
controlling the memory and interface to store the nutrition data in association with the determined time period.

15. A tracking system for nutrition data, comprising:
a first server that tracks food and drink purchases of a plurality of users; and
a second server communicating with the first server of a network, wherein the second server, in response to a request received from a user computing device: (i) queries the first server for data that meet conditions set forth in the request, the conditions including a user identification code and a time period of interest; (ii) generates nutrition data based on first data returned by the first server (iii) transforms the nutrition data into image data; and (iv) transmits the image data representative of the nutrition data to the user computing device.

16. The tracking system according to claim 15, wherein the nutrition data represent at least one of distribution of each of plural nutrients and total calories of the food and drink purchased by the user.

17. The tracking system according to claim 15, wherein the time period of interest is one of a default time period and a selected time period included in the request.

18. The tracking system according to claim 15, wherein the time period of interest is one of a selected meal or a selected time period.

19. The tracking system according to claim 15, wherein the second server, in response to a period change request received from the user computing device, (i) queries the first server for revised data that meet conditions set forth in the period change request, the conditions including a changed time period of interest; (ii) generates revised nutrition data based on second data returned by the first server; (iii) transforms the revised nutrition data into revised image data; and (iv) transmits the revised image data representative of the revised nutrition data to the user computing device.

20. The tracking system according to claim 15, wherein the request received from the user computing device includes activity data from an activity tracking device, and the image data representative of the nutrition data is further representative of the activity data.
